(19) United States
(12) Patent Application Publication
(10) Pub. No.: US 2020/0247997 A1
(43) Pub. Date: Aug. 6, 2020

(54) WOOD-BASED COMPOSITES AND ASSOCIATED COMPOSITIONS

(71) Applicant: Weyerhaeuser NR Company, Federal Way, WA (US)

(72) Inventors: Jack Winterowd, Puyallup, WA (US); Erik M. Parker, Bonney Lake, WA (US); Glen D. Robak, Bonney Lake, WA (US); Tony Pugel, Federal Way, WA (US)

(21) Appl. No.: 16/264,559

(22) Filed: Jan. 31, 2019

(51) Int. Cl. C08L 97/02; C09J 191/00; B27M 1/08; B27N 3/00; B27N 3/02

(52) U.S. Cl. CPC C08L 97/02; C09J 191/00; C08L 2205/03; B27N 3/002; B27N 3/02; B27M 1/08

(57) ABSTRACT

Wood-based composites, compositions for use in wood-based composites, and associated systems and methods are provided herein. Certain compositions include a mixture of alpha olefins and esters and demonstrate unique water repellant properties. The compositions may be incorporated in wood-based composites in place of traditional petroleum-based slack waxes.

### TECHNICAL FIELD

The present technology relates to wood-based composites, compositions for use in wood-based composites, and associated systems and methods.

### BACKGROUND

Structural and non-structural wood-based composites are manufactured in North America. Structural wood-based composites, such as oriented strand board, oriented strand lumber, long strand lumber, and parallel strand lumber, are used in the construction of commercial and residential structures. Non-structural wood-based composites, such as fiberboard and particleboard, are used in the furniture, cabinetry, and decorative flooring industry. All of these wood-based composites are manufactured in processes that involve compaction (pressing) of a mat of wooden elements (e.g., strands, fibers, particles) under high pressure in order to achieve a consolidated board or panel. Interestingly, wood has a high degree of ‘shape-memory’. If a piece of wood is compressed, for instance, if it is smashed with a hammer, then it will remain compressed until it is hydrated. As the compressed piece of wood absorbs water, it generally returns to its original shape and size. This remarkable characteristic also occurs in wood-based composites.

During residential construction it is common for wood-based composite parts (panels or beams) to be delivered to the building site with a previously established size and shape. These wood-based composite parts are then fit together and connected in an assembly process. It is therefore critical that the size and shape of each wood-based composite part remain within an established tolerance. If this does not happen, then the wood-based composite parts will need to be mechanically re-shaped before they can be fit together correctly.

Unfortunately, wood-based composites are frequently used in applications that involve the risk of exposure to either rain or high humidity. Water exposure can also occur as a result of envelope leaks (roofs, walls, windows, doors), and plumbing leaks. When this happens, the wood-based composites absorb water and swell. Due to ‘shape-memory’ characteristics, a portion of this swelling will not be reversible with subsequent drying. Thus, exposure of wood-based composites to water can significantly alter the size and shape of the object. The amount of swelling experienced can often be proportional to the amount of water that is absorbed. The amount of water absorbed depends on multiple factors that include the exposure time as well as the absorption rate of the wood-based composite.

There are additional problems with water absorption in wood-based composites. Water absorption and associated swelling can adversely affect the strength of a wood-based composite. In general, strength loss is greater when more water is absorbed. Thus, there is a structural advantage to manufacturing wood-based composites that absorb water at a slower rate. Furthermore, it is well known that when wood-based composites absorb water and hydrate to a moisture content of greater than about 20%, they can support the growth of certain molds and other microorganisms.

Manufacturers of wood-based composites have learned that water absorption rate can be decreased by incorporating wax into the product during the production process. Within certain limits, the reduction in water absorption rate can be improved by utilization of higher wax levels. Interestingly, some wax types reduce water absorption rate more than other wax types at a given dosing level. In general, manufacturers attempt to adjust the water absorption rate of the wood-based composite so that it maintains an acceptable level of dimensional stability in its intended application. Of course, manufacturers attempt to do this in a manner that is cost-effective and sustainable.

During the past 60 years in North America most of the wax used in the production of wood-based composites has been petroleum-based ‘slack wax’ with an oil content of about 10-35%. This type of wax is generally comprised of a mixture of normal and branched alkanes that range in molecular size from about 18 carbons (about 254 Daltons (Da)) to about 60 carbons (842 Da). Until about 2005, most of the slack wax used in North America was made in North America as a by-product of Group-1 lubricant base oil production. Group-1 base oil refineries subject petroleum to a fractional distillation process which yields both slack wax, lubricating oils, and other products. In general, the value of the lubricating oil has been greater than that of the slack wax. A newer refinery technology, known as Group-2 base oil production, involves hydrocracking of the slack wax fraction, which converts the slack wax portion of the petroleum into the more valuable lubricating oil. The transition of refineries from Group-1 base oil technology to Group-2 base oil technology has thus reduced the domestic production of slack wax. As this has occurred, the price of slack wax has increased. Today, significant levels of slack wax are being imported into North America in order to compensate for the diminished domestic production. Unfortunately, the imported slack wax sources are at risk to events such as embargos and new tariffs. The remaining Group-1 base oil refineries have been aided by relatively low petroleum costs for the past three years, but future increases in crude oil prices are likely to prompt more of these facilities to convert to Group-2 base oil technology.

In response to the above dynamics, so-called biowax products have emerged onto the North American wood-based composite market during the past ten years. Two of the prominent biowax products are hydrogenated soybean oil and hydrogenated tallow (beef). Both of these products are produced in North America and utilize a sustainable, economic set of raw materials. Many manufacturers of wood-based composites have evaluated these products and some are using them commercially. Unfortunately, most wood-based composite manufacturers have reached the conclusion that the biowax products do not reduce the water absorption rate of wood-based composites as much as petroleum slack wax does for a given wax dosage rate.

### BRIEF DESCRIPTION OF THE DRAWINGS

FIG. 1A and 1B are isometric views of a wood-based composite in accordance with one embodiment of the present technology.

FIG. 2 is a flow diagram of a method of manufacturing a wood-based composite in accordance with one embodiment of the present technology.

### DETAILED DESCRIPTION

Specific details of several embodiments of the disclosed technology are described below. Specific details describing structures or processes that are well-known but that can unnecessarily obscure some significant aspects of the present technology are not set forth in the following description for clarity. Moreover, although the following disclosure sets forth some embodiments of the different aspects of the disclosed technology, some embodiments of the technology can have configurations and/or components different than those described in this section. As such, the present technology can include some embodiments with additional elements and/or without several of the elements described below.

With regard to certain terms used herein, the terms “wax”, “compositions”, “wax compositions”, and “water repellant compositions” are used interchangeably to refer to water repellant agents used in wood-based composites. And as used herein, the term “about” means the stated value plus or minus 10%.

### Select Embodiments of Wax Compositions and Wood-Based Composites

Several embodiments of the present technology are directed towards wood-based composites and compositions for use in wood-based composites, including compositions comprising a mixture of alpha-olefins and esters. The compositions may act as a water repelling agent when applied to and/or incorporated in wood-based composites. For example, the compositions may be configured to reduce water absorption and/or swelling by the wood-based composite when the wood-based composite is exposed to water. The present technology also includes wood-based composites incorporating the compositions, and associated systems and methods.

As stated above, the present technology includes compositions comprising alpha olefins and esters. The ester component may be a single ester or a mixture of esters. Suitable esters include triglycerides (based on glycerol and three fatty acids) or compounds containing only one or two ester functional groups. The acid component (precursor) of the ester may be stearic acid (18 carbons, saturated), palmitic acid (16 carbons, saturated), or oleic acid (18 carbons, unsaturated). Suitable esters may have a melt point in the range of about 30-60° C. In some embodiments, the esters present in the composition include those which are derived from plants or animals. If the esters are obtained from plants or animals, the esters may be subjected to preliminary processing steps such as bleaching, refining, deodorizing, and/or hydrogenation. Nonlimiting examples of suitable esters include hydrogenated soybean oil, hydrogenated castor oil, hydrogenated cotton seed oil, hydrogenated sunflower oil, tallow, and hydrogenated tallow. Manufacturers of plant-derived triglycerides in North America include Archer Daniels Midland [Mankato, Minn.]. Manufacturers of animal-derived triglycerides in North America include South Chicago Packing [Chicago, Ill.].

Compositions of the present technology may also include alpha olefins. Alpha olefins are compounds comprised of carbon and hydrogen that contain a double bond between the first and second carbons of one end of the molecule (e.g., 1-hexene). The alpha olefin component may be a single alpha olefin or a mixture of alpha olefins. In some embodiments, the alpha-olefin molecules can be derived from ethylene. Alpha olefins suitable for use in compositions in accordance with the present technology may contain about 20 carbons or more. For example, in some embodiments, the alpha olefins contain about 20-26 carbons (about 280-364 Da). In some embodiments, the alpha olefins have a melt point of about 35-80° C. Non-limiting commercial examples of suitable alpha olefins are Neodene 26+ produced by Shell Oil Company [New Orleans, La.] and AlphaPlus+ C30 manufactured by Chevron Phillips Chemical Company [Baytown, Tex.]. Suitable alpha olefins can be manufactured by a number of different methods, but a common commercial method involves oligomerization of ethylene by use of a Ziegler-Natta catalyst and subsequent separation and isolation of the targeted alpha olefin molecular weight range. Ethylene is produced in vast quantities in North America by steam cracking of various hydrocarbons (including naphtha).

In certain compositions of the present technology, the alpha olefins may have a specific molecular weight range. For example, in some embodiments, the alpha olefins have a molecular weight between about 240-400 Da, and, in some embodiments, the alpha olefins have a molecular weight between about 280-364 Da. As will be discussed further herein, alpha olefins with a molecular weight between about 280-364 Da reduce the water absorption rate of wood-based composites to a greater extent than alpha olefins with an average molecular weight that is greater than about 420 Da. This discovery was unexpected and is not explained by any theory found in the literature.

The mass ratio of alpha-olefins to esters in the mixture may be any ratio between about 2:8 and 8:2. For example, the ratio of alpha-olefins to esters may be about 2:8, about 3:8, about 4:8, about 5:8, about 6:8, about 7:8, about 8:8, about 8:7, about 8:6, about 8:5, about 8:4, about 8:3, or about 8:2. Other ratios within the range between 2:8 and 8:2 are also possible and are within the scope of the present technology. For example, the alpha olefin may have a molecular weight between about 280-364 Da and the ratio of alpha olefin to ester may be between about 3:7 to 7:3. As another example, the alpha olefin may have a molecular weight between about 280-364 Da and the ratio of alpha olefin to ester may be between about 5:5 to 7:3. One skilled in the art will recognize a variety of various ratios may be utilized to emphasize certain properties of the resultant composition. Such ratios are within the scope of the present technology, even if not explicitly disclosed herein.

To prepare the compositions described herein, each component (e.g., the alpha olefin component and the ester component) may be melted and mixed together at the desired mass ratio (e.g., a ratio between 80 parts alpha olefins to 20 parts esters and 20 parts alpha olefins to 80 parts esters). In some embodiments, the components are mixed at a temperature about 15-30° C. greater than the melting point of the component which has the highest melting point.

The components and resultant compositions described herein may have several properties beneficial in the manufacturing, storage, and application of the wax compositions. For example, in a molten state, each component may have a kinematic viscosity that is less than about 10 Cps. Moreover, the molten components are miscible with each other, and the molten viscosity of the resultant mixture is also quite low. Thus, only a modest level of agitation is required to create a homogenous mixture. Once formed, the mixture will not spontaneously separate. Thus, commercial production of compositions of the present technology can be accomplished by use of a heated tank and a variable-speed mixing propeller. In some embodiments, each component is melted prior to addition to the tank. In other embodiments, the components are added together prior to melting. Scales or flow meters can be used to ensure that the components are added at the proper ratio. In some embodiments, small amounts of other components, such as Fischer-Tropsch waxes, hydrocarbon waxes, petroleum waxes, and/or paraffin waxes, can be included in the composition as long as the ratio of alpha olefin to ester is within the specified range.

Wax compositions in accordance with the present technology may have a freezing point which enables the wax to be stored in traditional wax storage containers. Manufacturing sites for wood-based composites may include one or more large storage tanks for the wax. If the wax is being used as a neat, molten liquid, then the wax storage tank is typically heated and insulated. Additionally, plumbing between the storage tank and the blending equipment is typically heated and insulated so that the molten wax does not freeze as it is being pumped to the application equipment. To help prevent the wax from freezing before application, the wax freezing point may be less than about 65° C., less than about 60° C., or less than about 55° C.

Wax compositions in accordance with the present technology may have a low viscosity when in molten form. This is advantageous for several reasons. First, the molten wax may simply be sprayed onto the wooden elements at a blender. During the spray application process, it is desirable for the wax to have a low molten viscosity (kinematic viscosity of about 10 cPs or less) and a low freezing point (55-60° C.) so that the molten wax spray droplets do not freeze before they land on the surface of the wooden elements. Wax droplets that freeze prior to contacting a wooden element surface generally exist as tiny spheres. These wax spheres tend to bounce off of the wooden surface and fall to the bottom of the blender. Second, for some wood-based composites, it is helpful for the wax to act as a slip-aid or lubricant. For instance, in the process of making oriented strand board, it is common for blended strands to be transported through chutes at a rate that approaches the maximum flow rate capacity of the chute. In the absence of the wax acting as a lubricant, the blended strands can form plugs in the chutes.

Wax compositions in accordance with the present technology may also exhibit suitable levels of volatility for use in manufacturing wood-based composites. As the formed mat enters the hot-press, it is important that the wax exhibit some limited level of volatility so that it is retained in the board and does not evaporate. This is important because wax products that are highly volatile at elevated temperature tend to condense in ventilation ducts in the wood-based composite manufacturing process. This condensate must be periodically removed so that the ducts can continue to transfer air and other gases. Thus, the volatility of the wax may be less than about 200 mg/min/m² at a temperature of 163° C. Additionally, the wax may have an auto-ignition temperature that is greater than that of the hot-press. By having a relatively high auto-ignition temperature, the risk of fire as the wood-based composite is pressed at temperatures as high as about 220° C. is minimized. Thus, in some embodiments, the auto-ignition temperature of the wax should be greater than about 250° C. (ASTM D1929).

Wax compositions in accordance with the present technology may have several additional attributes which make them suitable for use as a wax in wood-based composites. For example, certain compositions may be subjected to multiple freeze/thaw cycles without degradation. Moreover, in its molten form, the composition may have relatively low odor and may be pumped and sprayed. And in its solid form, the composition may be a white, waxy solid. Additionally, the compositions may also substantially reduce the water absorption rate and/or swelling of wood-based composites with relatively low dosage levels, and may not substantially interfere with the performance of the bonding resin. Accordingly, wood-based composites made with the wax compositions described herein may be about as strong as wood-based composites made without the wax or with a traditional wax. The compositions may also be manufactured using raw materials that are sustainably sourced from North America.

At least several of these attributes stem from the combinations of alpha olefins and esters as described herein. For example, the use of alpha-olefins alone may be associated with several issues: a higher than ideal volatility and an adverse effect on the internal bond strength. However, the ester component present in certain embodiments of the present technology reduces the volatility of the compositions and helps maintain the internal bond strength of the wood-based composites treated with the compositions. While an alpha olefin with a molecular weight range of about 280-364 Da may be suitable for use alone in some environments, such compositions may also be too volatile to use in many wood-based composite manufacturing processes. Furthermore, 100% alpha olefin waxes may reduce the internal bond strength in the wood-based composites. However, compounding the alpha olefin (especially alpha olefin having a molecular weight between about 280-364 Da) with certain esters, such as fatty acid triglycerides, helps maintain internal bond strengths.

As stated above, the present technology also includes wood-based composites incorporating the compositions described herein. Such wood-based composites may include wood elements (e.g., strands, fibers, and/or particles), a bonding resin, and a wax composition. The bonding resin may be present at about 2.0-7.0% of the dry mass of the wood elements, and the wax composition may be present at about 0.1-3.0% of the dry mass of the wood elements. The wax composition may take any form as described herein and may be incorporated into a wood-based composite as a neat molten wax and/or may be incorporated into a water-based emulsion (using surfactants and a homogenizer) and the emulsion can be incorporated into a wood-based composite. Thus, the compositions may be incorporated into the wood-based composite at one or more points during and/or after the manufacturing process. As will be recognized by one of skill in the art, compositions in accordance with the present technology may be utilized in a variety of methods of manufacturing wood-based composites.

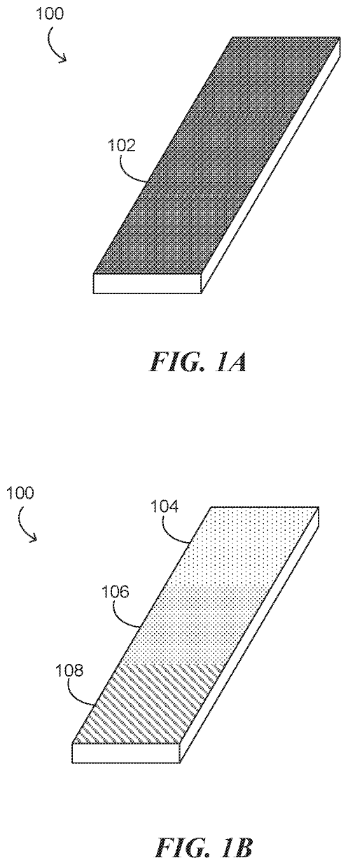

FIGS. 1A and 1B illustrate one embodiment of a wood-based composite according to the present technology. In FIG. 1A, a wood-based composite 100 includes a region 102 comprising wood elements, a bonding resin, and a wax composition. In FIG. 1B, the region 102 has been divided into three sub-regions to better depict several features of the wood-based composite 100. As illustrated, the wood-based composite 100 includes a wax composition 104, a bonding resin 106, and wood elements 108. The wax composition 104 may, for example, comprise a mixture of alpha olefins and esters as described herein. Although depicted schematically as three separate regions, in practice the wax composition 104, the bonding resin 106, and the wood elements 108 are mixed together and/or applied such that they are present throughout substantially all of region 102 (i.e., the wax composition 104, the bonding resin 106, and the wood elements 108 combine to form the region 102 as depicted in FIG. 1A). As can be appreciated by one of skill in the art, FIGS. 1A and 1B are a single example and the present technology includes wood-based composites of varying shapes, sizes, and compositions.

To manufacture wood-based composites, logs from trees and other wood sources are converted into wood elements (e.g., strands, fibers or particles). Once formed, the wooden elements may be dried to a moisture content that can range from about 2-12% depending on the type of composite that is being produced. The wood elements may then be treated on the surface with bonding resin and a wax composition. As discussed above, the wax composition can be sprayed onto the surface of the wood elements or can be applied with other blending technologies, such as the Turbo Blender, in which the wax is simply injected into a blender that is packed with particles that are being pushed through the blender with paddles on a rotating shaft. After the wood elements have been treated on the surface with the wax composition and resin, they are formed into a mat (e.g., on a continuous line). The mat may then be consolidated in a hot-press to form a board, and subsequently may be cut into smaller pieces, sanded on one or more surfaces, profiled on the edges, marked with stamps, sealed, bundled, packaged, and/or labeled.

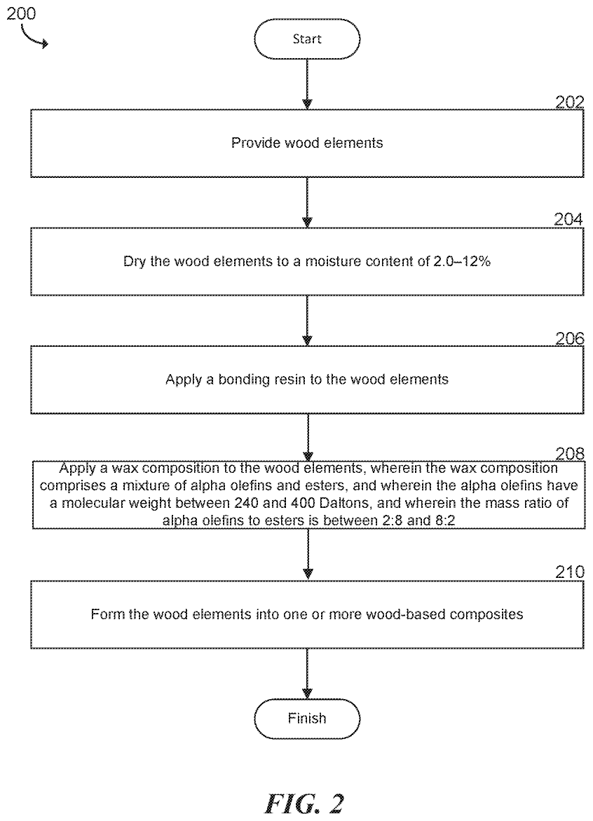

FIG. 2 is a flowchart of a method 200 of manufacturing a wood-based composite in accordance with one aspect of the present technology. Method 200 includes providing wood elements and drying the wood elements to a moisture content of 2.0-12% (process steps 202 and 204). Method 200 further includes applying a bonding resin to the wood elements (process step 206). A number of bonding resins for use in wood-based composites are known in the art and are suitable for use herein. Method 200 further includes applying a wax composition to the wood elements (process step 208). In method 200, the wax composition comprises a mixture of alpha olefins and esters, the alpha olefins have a molecular weight between 240 and 400 Da, and the mass ratio of alpha olefins to esters is between 2:8 and 8:2. Method 200 further includes forming the wood elements into one or more wood-based composites (process step 210).

### EXAMPLES

The following examples are illustrative of several embodiments of the present technology.

### Example 1

Wax-free oriented strand board was produced in the laboratory in the following manner. Wooden strands (0.025-0.045 inches thick, 0.25-1.5 inches wide, 0.25-5.0 inches long, about 80% aspen and 20% black poplar) were designated as ‘core layer’ strands and were dried to a moisture content of about 3-4%. The strands were then transferred into a front-load, cylindrically-shaped, rotating blender compartment (2 feet deep and 6 feet in diameter). The axis of rotation was parallel to the laboratory floor. The rotating interior surface of the compartment was equipped with an array of protruding pegs (2 inches in length and 0.25 inches in diameter), which were effective at catching strands during rotation and carrying them to the upper region of the compartment. The rotation rate of the blender was 11 rpm. In conjunction with the pegs, this rate of rotation resulted in strands being carried to a top region of the blender and then falling to the bottom in a continuous, waterfall-like action. The blender was further equipped with spray nozzles that dispensed bonding resins and waxes into the falling strands at predetermined dosage application levels.

An isocyanate type bonding resin, known as M20FB (manufactured by the BASF Corporation, Wyandotte, Mich.) was sprayed onto the core strands at an application level of 4.3% of the dry mass of the strands. The strands were further treated with water at an application level of 2.0% of the dry mass of the strands. The treated core layer strands were then removed from the blender.

Additional wooden strands (0.025-0.045 inches thick, 0.25-1.5 inches wide, 0.25-5.0 inches long, about 80% aspen and 20% black poplar) were designated as ‘surface layer’ strands and were dried to a moisture content of about 3-4%. The strands were then transferred into the blender compartment.

A phenol-formaldehyde type bonding resin, known as WE1029 (manufactured by Hexion Specialty Chemicals, Columbus, Ohio) was sprayed onto the surface strands at an application level of 5.5% of the dry mass of the strands. The treated surface layer strands were then removed from the blender.

The treated strands were formed on top of an ⅛″ aluminum caul plate and a stainless-steel screen into a three-layered mat (24″ long×24″ wide) that was comprised of a bottom layer, a core layer and a top layer. The mass ratio of the outer layers to the core layer was 52:48. The strands in the top and bottom layers were generally oriented parallel to the length of the mat. The strands in the core layer were generally oriented parallel to the width of the mat. The thickness of the mat was about 5 inches and the wet mass was about 12,000 g.

The mat, as well as the underlying caul plate and screen (screen was in direct contact with the bottom of the mat), were transferred into a lab-scale, single-opening hot-press. The platens in the press had a length of 24″ and a width of 24″. The surface of the platens prior to pressing were maintained at a temperature of about 210° C. The press was immediately closed until the gap between the top and bottom platens was 0.719 inches. The closing step occurred over a 30 second period. The distance between the top and bottom platens was maintained at a distance of 0.719 inches for a period of 160 s. The gap between the top and bottom platens was then increased to 0.780 inches over a 61 second period. The press was then rapidly opened and the resulting oriented strand board panel was removed from the press and transferred into a ventilated oven at a temperature of 80° C. for a period of 24 hours. The panel was then removed from the oven and placed into a conditioning chamber (50% R.H., 20° C.) for a period of at least 5 days.

Six replicate panels were made in this manner. Test specimens (1″×1″, 6 count) for a soak test were cut from each panel. Additional test specimens (2″×2″, 4 count) for a dry, non-cycled, internal bond strength test (ASTM D1037) were cut from each panel.

For the soak test each specimen was initially measured for mass, width, length and thickness. All caliper measurements were made in the center of the targeted specimen surface with a Mitutoyo ID F150E Digimatic Indicator, which was equipped with a 0.5″ diameter measurement disk. Specimens were then loaded into cages in order to ensure that they were maintained in a horizontal orientation and were then submerged in water at a temperature of 20° C. such that the top of each specimen was about 1.6 inches under the surface of the water. Each specimen was submerged in the water under these conditions for a period of 7 hours and was then removed from the water and measured for mass and thickness. Based on these measurements, calculations were made regarding the water absorption and thickness swell that had occurred during the 7-hour soaking period. In general, the following equations were used for the calculations:

Water Absorption (%)=100% [(wet specimen mass)−(initial specimen mass)]/[(initial specimen mass)]

Thickness Swell (%)=100% [(wet specimen thickness)−(initial specimen thickness)]/[(initial specimen thickness)]

The results are summarized in Table 1. In this table the individual values for replicate test specimens within a panel have been averaged together.

TABLE 1
Test Values for Oriented Strand Board Made with No Wax

| | | | INTERNAL |
|---|---|---|---|
| | WATER | THICKNESS | BOND |
| | ABSORPTION (%) | SWELL (%) | STRENGTH |
| PANEL | IN 7 HOURS | IN 7 HOURS | (PSI) |
| 1 | 80.7 | 23.1 | 34.2 |
| 2 | 95.0 | 20.3 | 55.0 |
| 3 | 81.8 | 26.1 | 54.8 |
| 4 | 86.0 | 21.9 | 40.2 |
| 5 | 88.8 | 20.5 | 55.5 |
| 6 | 84.1 | 20.3 | 47.7 |
| AVERAGE | 86.1 | 22.0 | 47.9 |

### Example 2

Oriented strand board was produced in the laboratory with a first conventional petroleum-based slack wax in the following manner. Wooden strands (0.025-0.045 inches thick, 0.25-1.5 inches wide, 0.25-5.0 inches long, about 80% aspen and 20% black poplar) were designated as ‘core layer’ strands and were dried to a moisture content of about 3-4%. The strands were then transferred into a front-load, cylindrically-shaped, rotating blender compartment (2 feet deep and 6 feet in diameter). The axis of rotation was parallel to the laboratory floor. The rotating interior surface of the compartment was equipped with an array of protruding pegs (2 inches in length and 0.25 inches in diameter), which were effective at catching strands during rotation and carrying them to the upper region of the compartment. The rotation rate of the blender was 11 rpm. In conjunction with the pegs, this rate of rotation resulted in strands being carried to a top region of the blender and then falling to the bottom in a continuous, waterfall-like action. The blender was further equipped with spray nozzles that dispensed bonding resins and waxes into the falling strands at predetermined dosage application levels.

A conventional petroleum-based slack wax, known as 431B (manufactured by the International Group Incorporated, Toronto, ON), was heated to a temperature of 107° C. and sprayed onto the core strands at an application level of 0.5% of the dry mass of the strands. An isocyanate type bonding resin, known as M20FB (manufactured by the BASF Corporation, Wyandotte, Mich.) was sprayed onto the core strands at an application level of 4.3% of the dry mass of the strands. The core strands were further treated with water at an application level of 2.0% of the dry mass of the strands. The treated core layer strands were then removed from the blender.

Additional wooden strands (0.025-0.045 inches thick, 0.25-1.5 inches wide, 0.25-5.0 inches long, about 80% aspen and 20% black poplar) were designated as ‘surface layer’ strands and were dried to a moisture content of about 3-4%. The strands were then transferred into the blender compartment.

A conventional petroleum-based slack wax, known as 431B (manufactured by the International Group Incorporated, Toronto, ON), was heated to a temperature of 107° C. and sprayed onto the surface strands at an application level of 0.5% of the dry mass of the strands. A phenol-formaldehyde type bonding resin, known as WE1029 (manufactured by Hexion Specialty Chemicals, Columbus, Ohio) was sprayed onto the surface strands at an application level of 5.5% of the dry mass of the strands. The treated surface layer strands were then removed from the blender.

The treated strands were formed on top of an ⅛″ aluminum caul plate and a stainless-steel screen into a three-layered mat (24″ long×24″ wide) that was comprised of a bottom layer, a core layer and a top layer. The mass ratio of the outer layers to the core layer was 52:48. The strands in the top and bottom layers were generally oriented parallel to the length of the mat. The strands in the core layer were generally oriented parallel to the width of the mat. The thickness of the mat was about 5 inches and the wet mass was about 12,000 g.

The mat, as well as the underlying caul plate and screen (screen was in direct contact with the bottom of the mat), were transferred into a lab-scale, single-opening hot-press. The platens in the press had a length of 24″ and a width of 24″. The surface of the platens prior to pressing were maintained at a temperature of about 210° C. The press was immediately closed until the gap between the top and bottom platens was 0.719 inches. The closing step occurred over a 30 second period. The distance between the top and bottom platens was maintained at a distance of 0.719 inches for a period of 160 s. The gap between the top and bottom platens was then increased to 0.780 inches over a 61 second period. The press was then rapidly opened and the resulting oriented strand board panel was removed from the press and transferred into a ventilated oven at a temperature of 80° C. for a period of 24 hours. The panel was then removed from the oven and placed into a conditioning chamber (50% R.H., 20° C.) for a period of at least 5 days.

Six replicate panels were made in this manner. Test specimens (1″×1″, 6 count) for a soak test were cut from each panel. Additional test specimens (2″×2″, 4 count) for a dry, non-cycled, internal bond strength test (ASTM D1037) were cut from each panel.

For the soak test each specimen was initially measured for mass, width, length and thickness. All caliper measurements were made in the center of the targeted specimen surface with a Mitutoyo ID F150E Digimatic Indicator, which was equipped with a 0.5″ diameter measurement disk. Specimens were then loaded into cages in order to ensure that they were maintained in a horizontal orientation and were then submerged in water at a temperature of 20° C. such that the top of each specimen was about 1.6 inches under the surface of the water. Each specimen was submerged in the water under these conditions for a period of 7 hours and was then removed from the water and measured for mass and thickness. Based on these measurements, calculations were made regarding the water absorption and thickness swell that had occurred during the 7-hour soaking period. In general, the following equations were used for the calculations:

Water Absorption (%)=100% [(wet specimen mass)−(initial specimen mass)]/[(initial specimen mass)]

Thickness Swell (%)=100% [(wet specimen thickness)−(initial specimen thickness)]/[(initial specimen thickness)]

The results are summarized in Table 2. In this table the individual values for replicate test specimens within a panel have been averaged together.

TABLE 2
Test Values for Oriented Strand Board Made with a
First Conventional Petroleum-Based Slack Wax (431B)

| | | | INTERNAL |
|---|---|---|---|
| | WATER | THICKNESS | BOND |
| | ABSORPTION (%) | SWELL (%) | STRENGTH |
| PANEL | IN 7 HOURS | IN 7 HOURS | (PSI) |
| 1 | 52.7 | 15.4 | 46.9 |
| 2 | 51.2 | 14.0 | 61.4 |
| 3 | 56.1 | 14.1 | 48.4 |
| 4 | 52.6 | 13.4 | 48.3 |
| 5 | 60.8 | 17.4 | 59.1 |
| 6 | 54.9 | 15.1 | 58.3 |
| AVERAGE | 54.7 | 14.9 | 53.7 |

### Example 3

Oriented strand board was produced in the laboratory with a second conventional petroleum-based slack wax in the following manner. Wooden strands (0.025-0.045 inches thick, 0.25-1.5 inches wide, 0.25-5.0 inches long, about 80% aspen and 20% black poplar) were designated as ‘core layer’ strands and were dried to a moisture content of about 3-4%. The strands were then transferred into a front-load, cylindrically-shaped, rotating blender compartment (2 feet deep and 6 feet in diameter). The axis of rotation was parallel to the laboratory floor. The rotating interior surface of the compartment was equipped with an array of protruding pegs (2 inches in length and 0.25 inches in diameter), which were effective at catching strands during rotation and carrying them to the upper region of the compartment. The rotation rate of the blender was 11 rpm. In conjunction with the pegs, this rate of rotation resulted in strands being carried to a top region of the blender and then falling to the bottom in a continuous, waterfall-like action. The blender was further equipped with spray nozzles that dispensed bonding resins and waxes into the falling strands at predetermined dosage application levels.

A conventional petroleum-based slack wax, known as ProWax 561 (manufactured by the ExxonMobil Corporation, Baytown, Tex.), was heated to a temperature of 107° C. and sprayed onto the core strands at an application level of 0.5% of the dry mass of the strands. An isocyanate type bonding resin, known as M20FB (manufactured by the BASF Corporation, Wyandotte, Mich.) was sprayed onto the core strands at an application level of 4.3% of the dry mass of the strands. The core strands were further treated with water at an application level of 2.0% of the dry mass of the strands. The treated core layer strands were then removed from the blender.

Additional wooden strands (0.025-0.045 inches thick, 0.25-1.5 inches wide, 0.25-5.0 inches long, about 80% aspen and 20% black poplar) were designated as ‘surface layer’ strands and were dried to a moisture content of about 3-4%. The strands were then transferred into the blender compartment.

A conventional petroleum-based slack wax, known as ProWax 561 (manufactured by the ExxonMobil Corporation, Baytown, Tex.), was heated to a temperature of 107° C. and sprayed onto the surface strands at an application level of 0.5% of the dry mass of the strands. A phenol-formaldehyde type bonding resin, known as WE1029 (manufactured by Hexion Specialty Chemicals, Columbus, Ohio) was sprayed onto the surface strands at an application level of 5.5% of the dry mass of the strands. The treated surface layer strands were then removed from the blender.

The treated strands were formed on top of an ⅛″ aluminum caul plate and a stainless-steel screen into a three-layered mat (24″ long×24″ wide) that was comprised of a bottom layer, a core layer and a top layer. The mass ratio of the outer layers to the core layer was 52:48. The strands in the top and bottom layers were generally oriented parallel to the length of the mat. The strands in the core layer were generally oriented parallel to the width of the mat. The thickness of the mat was about 5 inches and the wet mass was about 12,000 g.

The mat, as well as the underlying caul plate and screen (screen was in direct contact with the bottom of the mat), were transferred into a lab-scale, single-opening hot-press. The platens in the press had a length of 24″ and a width of 24″. The surface of the platens prior to pressing were maintained at a temperature of about 210° C. The press was immediately closed until the gap between the top and bottom platens was 0.719 inches. The closing step occurred over a 30 second period. The distance between the top and bottom platens was maintained at a distance of 0.719 inches for a period of 160 s. The gap between the top and bottom platens was then increased to 0.780 inches over a 61 second period. The press was then rapidly opened and the resulting oriented strand board panel was removed from the press and transferred into a ventilated oven at a temperature of 80° C. for a period of 24 hours. The panel was then removed from the oven and placed into a conditioning chamber (50% R.H., 20° C.) for a period of at least 5 days.

Six replicate panels were made in this manner. Test specimens (1″×1″, 6 count) for a soak test were cut from each panel. Additional test specimens (2″×2″, 4 count) for a dry, non-cycled, internal bond strength test (ASTM D1037) were cut from each panel.

For the soak test each specimen was initially measured for mass, width, length and thickness. All caliper measurements were made in the center of the targeted specimen surface with a Mitutoyo ID F150E Digimatic Indicator, which was equipped with a 0.5″ diameter measurement disk. Specimens were then loaded into cages in order to ensure that they were maintained in a horizontal orientation and were then submerged in water at a temperature of 20° C. such that the top of each specimen was about 1.6 inches under the surface of the water. Each specimen was submerged in the water under these conditions for a period of 7 hours and was then removed from the water and measured for mass and thickness. Based on these measurements, calculations were made regarding the water absorption and thickness swell that had occurred during the 7-hour soaking period. In general, the following equations were used for the calculations:

Water Absorption (%)=100% [(wet specimen mass)−(initial specimen mass)]/[(initial specimen mass)]

Thickness Swell (%)=100% [(wet specimen thickness)−(initial specimen thickness)]/[(initial specimen thickness)]

The results are summarized in Table 3. In this table the individual values for replicate test specimens within a panel have been averaged together.

TABLE 3
Test Values for Oriented Strand Board Made with a Second
Conventional Petroleum-Based Slack Wax (ProWax 561)

| | | | INTERNAL |
|---|---|---|---|
| | WATER | THICKNESS | BOND |
| | ABSORPTION (%) | SWELL (%) | STRENGTH |
| PANEL | IN 7 HOURS | IN 7 HOURS | (PSI) |
| 1 | 52.6 | 15.5 | 54.4 |
| 2 | 52.1 | 15.9 | 47.0 |
| 3 | 57.6 | 16.9 | 63.2 |
| 4 | 56.4 | 18.1 | 48.4 |
| 5 | 55.5 | 17.2 | 50.3 |
| 6 | 56.1 | 17.9 | 39.6 |
| AVERAGE | 55.1 | 16.9 | 50.5 |

### Example 4

Oriented strand board was produced in the laboratory with an ester (hydrogenated soybean oil) wax in the following manner. Wooden strands (0.025-0.045 inches thick, 0.25-1.5 inches wide, 0.25-5.0 inches long, about 80% aspen and 20% black poplar) were designated as ‘core layer’ strands and were dried to a moisture content of about 3-4%. The strands were then transferred into a front-load, cylindrically-shaped, rotating blender compartment (2 feet deep and 6 feet in diameter). The axis of rotation was parallel to the laboratory floor. The rotating interior surface of the compartment was equipped with an array of protruding pegs (2 inches in length and 0.25 inches in diameter), which were effective at catching strands during rotation and carrying them to the upper region of the compartment. The rotation rate of the blender was 11 rpm. In conjunction with the pegs, this rate of rotation resulted in strands being carried to a top region of the blender and then falling to the bottom in a continuous, waterfall-like action. The blender was further equipped with spray nozzles that dispensed bonding resins and waxes into the falling strands at predetermined dosage application levels.

A hydrogenated soybean oil wax, known as 885820 (manufactured by Archer Daniels Midland, Mankato, Minn.), was heated to a temperature of 107° C. and sprayed onto the core strands at an application level of 0.5% of the dry mass of the strands. An isocyanate type bonding resin, known as M20FB (manufactured by the BASF Corporation, Wyandotte, Mich.) was sprayed onto the core strands at an application level of 4.3% of the dry mass of the strands. The core strands were further treated with water at an application level of 2.0% of the dry mass of the strands. The treated core layer strands were then removed from the blender.

Additional wooden strands (0.025-0.045 inches thick, 0.25-1.5 inches wide, 0.25-5.0 inches long, about 80% aspen and 20% black poplar) were designated as ‘surface layer’ strands and were dried to a moisture content of about 3-4%. The strands were then transferred into the blender compartment.

A hydrogenated soybean oil wax, known as 885820 (manufactured by Archer Daniels Midland, Mankato, Minn.), was heated to a temperature of 107° C. and sprayed onto the surface strands at an application level of 0.5% of the dry mass of the strands. A phenol-formaldehyde type bonding resin, known as WE1029 (manufactured by Hexion Specialty Chemicals, Columbus, Ohio) was sprayed onto the surface strands at an application level of 5.5% of the dry mass of the strands. The treated surface layer strands were then removed from the blender.

The treated strands were formed on top of an ⅛″ aluminum caul plate and a stainless-steel screen into a three-layered mat (24″ long×24″ wide) that was comprised of a bottom layer, a core layer and a top layer. The mass ratio of the outer layers to the core layer was 52:48. The strands in the top and bottom layers were generally oriented parallel to the length of the mat. The strands in the core layer were generally oriented parallel to the width of the mat. The thickness of the mat was about 5 inches and the wet mass was about 12,000 g.

The mat, as well as the underlying caul plate and screen (screen was in direct contact with the bottom of the mat), were transferred into a lab-scale, single-opening hot-press. The platens in the press had a length of 24″ and a width of 24″. The surface of the platens prior to pressing were maintained at a temperature of about 210° C. The press was immediately closed until the gap between the top and bottom platens was 0.719 inches. The closing step occurred over a 30 second period. The distance between the top and bottom platens was maintained at a distance of 0.719 inches for a period of 160 s. The gap between the top and bottom platens was then increased to 0.780 inches over a 61 second period. The press was then rapidly opened and the resulting oriented strand board panel was removed from the press and transferred into a ventilated oven at a temperature of 80° C. for a period of 24 hours. The panel was then removed from the oven and placed into a conditioning chamber (50% R.H., 20° C.) for a period of at least 5 days.

Six replicate panels were made in this manner. Test specimens (1″×1″, 6 count) for a soak test were cut from each panel. Additional test specimens (2″×2″, 4 count) for a dry, non-cycled, internal bond strength test (ASTM D1037) were cut from each panel.

For the soak test each specimen was initially measured for mass, width, length and thickness. All caliper measurements were made in the center of the targeted specimen surface with a Mitutoyo ID F150E Digimatic Indicator, which was equipped with a 0.5″ diameter measurement disk. Specimens were then loaded into cages in order to ensure that they were maintained in a horizontal orientation and were then submerged in water at a temperature of 20° C. such that the top of each specimen was about 1.6 inches under the surface of the water. Each specimen was submerged in the water under these conditions for a period of 7 hours and was then removed from the water and measured for mass and thickness. Based on these measurements, calculations were made regarding the water absorption and thickness swell that had occurred during the 7-hour soaking period. In general, the following equations were used for the calculations:

Water Absorption (%)=100% [(wet specimen mass)−(initial specimen mass)]/[(initial specimen mass)]

Thickness Swell (%)=100% [(wet specimen thickness)−(initial specimen thickness)]/[(initial specimen thickness)]

The results are summarized in Table 4. In this table the individual values for replicate test specimens within a panel have been averaged together.

TABLE 4
Test Values for Oriented Strand Board Made with
an Ester (Hydrogenated Soybean Oil Wax)

| | | | INTERNAL |
|---|---|---|---|
| | WATER | THICKNESS | BOND |
| | ABSORPTION (%) | SWELL (%) | STRENGTH |
| PANEL | IN 7 HOURS | IN 7 HOURS | (PSI) |
| 1 | 66.0 | 16.7 | 53.7 |
| 2 | 63.7 | 20.1 | 52.7 |
| 3 | 65.5 | 18.7 | 29.1 |
| 4 | 73.7 | 18.9 | 50.7 |
| 5 | 72.9 | 21.0 | 49.3 |
| 6 | 72.0 | 20.7 | 52.6 |
| AVERAGE | 69.0 | 19.4 | 48.0 |

### Example 5

Oriented strand board was produced in the laboratory with an alpha olefin having a molecular weight range of about 280-364 Da. Wooden strands (0.025-0.045 inches thick, 0.25-1.5 inches wide, 0.25-5.0 inches long, about 80% aspen and 20% black poplar) were designated as ‘core layer’ strands and were dried to a moisture content of about 3-4%. The strands were then transferred into a front-load, cylindrically-shaped, rotating blender compartment (2 feet deep and 6 feet in diameter). The axis of rotation was parallel to the laboratory floor. The rotating interior surface of the compartment was equipped with an array of protruding pegs (2 inches in length and 0.25 inches in diameter), which were effective at catching strands during rotation and carrying them to the upper region of the compartment. The rotation rate of the blender was 11 rpm. In conjunction with the pegs, this rate of rotation resulted in strands being carried to a top region of the blender and then falling to the bottom in a continuous, waterfall-like action. The blender was further equipped with spray nozzles that dispensed bonding resins and waxes into the falling strands at predetermined dosage application levels.

An alpha olefin with a molecular weight range of about 280-364 Da, known as Neodene 26+ (manufactured by the Shell Oil Company, New Orleans, La.), was heated to a temperature of 107° C. and sprayed onto the core strands at an application level of 0.5% of the dry mass of the strands. An isocyanate type bonding resin, known as M20FB (manufactured by the BASF Corporation, Wyandotte, Mich.) was sprayed onto the core strands at an application level of 4.3% of the dry mass of the strands. The core strands were further treated with water at an application level of 2.0% of the dry mass of the strands. The treated core layer strands were then removed from the blender.

Additional wooden strands (0.025-0.045 inches thick, 0.25-1.5 inches wide, 0.25-5.0 inches long, about 80% aspen and 20% black poplar) were designated as ‘surface layer’ strands and were dried to a moisture content of about 3-4%. The strands were then transferred into the blender compartment.

An alpha olefin with a molecular weight range of about 280-364 Da, known as Neodene 26+ (manufactured by the Shell Oil Company, New Orleans, La.), was heated to a temperature of 107° C. and sprayed onto the surface strands at an application level of 0.5% of the dry mass of the strands. A phenol-formaldehyde type bonding resin, known as WE1029 (manufactured by Hexion Specialty Chemicals, Columbus, Ohio) was sprayed onto the surface strands at an application level of 5.5% of the dry mass of the strands. The treated surface layer strands were then removed from the blender.

The treated strands were formed on top of an ⅛″ aluminum caul plate and a stainless-steel screen into a three-layered mat (24″ long×24″ wide) that was comprised of a bottom layer, a core layer and a top layer. The mass ratio of the outer layers to the core layer was 52:48. The strands in the top and bottom layers were generally oriented parallel to the length of the mat. The strands in the core layer were generally oriented parallel to the width of the mat. The thickness of the mat was about 5 inches and the wet mass was about 12,000 g.

The mat, as well as the underlying caul plate and screen (screen was in direct contact with the bottom of the mat), were transferred into a lab-scale, single-opening hot-press. The platens in the press had a length of 24″ and a width of 24″. The surface of the platens prior to pressing were maintained at a temperature of about 210° C. The press was immediately closed until the gap between the top and bottom platens was 0.719 inches. The closing step occurred over a 30 second period. The distance between the top and bottom platens was maintained at a distance of 0.719 inches for a period of 160 s. The gap between the top and bottom platens was then increased to 0.780 inches over a 61 second period. The press was then rapidly opened and the resulting oriented strand board panel was removed from the press and transferred into a ventilated oven at a temperature of 80° C. for a period of 24 hours. The panel was then removed from the oven and placed into a conditioning chamber (50% R.H., 20° C.) for a period of at least 5 days.

Six replicate panels were made in this manner. Test specimens (1″×1″, 6 count) for a soak test were cut from each panel. Additional test specimens (2″×2″, 4 count) for a dry, non-cycled, internal bond strength test (ASTM D1037) were cut from each panel.

For the soak test each specimen was initially measured for mass, width, length and thickness. All caliper measurements were made in the center of the targeted specimen surface with a Mitutoyo ID F150E Digimatic Indicator, which was equipped with a 0.5″ diameter measurement disk. Specimens were then loaded into cages in order to ensure that they were maintained in a horizontal orientation and were then submerged in water at a temperature of 20° C. such that the top of each specimen was about 1.6 inches under the surface of the water. Each specimen was submerged in the water under these conditions for a period of 7 hours and was then removed from the water and measured for mass and thickness. Based on these measurements, calculations were made regarding the water absorption and thickness swell that had occurred during the 7-hour soaking period. In general, the following equations were used for the calculations:

Water Absorption (%)=100% [(wet specimen mass)−(initial specimen mass)]/[(initial specimen mass)]

Thickness Swell (%)=100% [(wet specimen thickness)−(initial specimen thickness)]/[(initial specimen thickness)]

The results are summarized in Table 5. In this table the individual values for replicate test specimens within a panel have been averaged together.

TABLE 5
Test Values for Oriented Strand Board Made with an Alpha Olefin
having a Molecular Weight Range of about 280-364 Da

| | | | INTERNAL |
|---|---|---|---|
| | WATER | THICKNESS | BOND |
| | ABSORPTION (%) | SWELL (%) | STRENGTH |
| PANEL | IN 7 HOURS | IN 7 HOURS | (PSI) |
| 1 | 49.4 | 14.8 | 42.0 |
| 2 | 48.2 | 14.2 | 44.5 |
| 3 | 49.4 | 15.2 | 38.1 |
| 4 | 44.5 | 14.3 | 36.3 |
| 5 | 45.4 | 13.6 | 45.0 |
| 6 | 45.1 | 13.6 | 43.7 |
| AVERAGE | 47.0 | 14.3 | 41.6 |

### Example 6

Oriented strand board was produced in the laboratory with an alpha olefin having a molecular weight greater than about 420 Da. Wooden strands (0.025-0.045 inches thick, 0.25-1.5 inches wide, 0.25-5.0 inches long, about 80% aspen and 20% black poplar) were designated as ‘core layer’ strands and were dried to a moisture content of about 3-4%. The strands were then transferred into a front-load, cylindrically-shaped, rotating blender compartment (2 feet deep and 6 feet in diameter). The axis of rotation was parallel to the laboratory floor. The rotating interior surface of the compartment was equipped with an array of protruding pegs (2 inches in length and 0.25 inches in diameter), which were effective at catching strands during rotation and carrying them to the upper region of the compartment. The rotation rate of the blender was 11 rpm. In conjunction with the pegs, this rate of rotation resulted in strands being carried to a top region of the blender and then falling to the bottom in a continuous, waterfall-like action. The blender was further equipped with spray nozzles that dispensed bonding resins and waxes into the falling strands at predetermined dosage application levels.

An alpha olefin with a molecular weight greater than about 420 Da, known as AlphaPlus C30+ (manufactured by Chevron Phillips Chemical Company, Baytown, Tex.), was heated to a temperature of 107° C. and sprayed onto the core strands at an application level of 0.5% of the dry mass of the strands. An isocyanate type bonding resin, known as M20FB (manufactured by the BASF Corporation, Wyandotte, Mich.) was sprayed onto the core strands at an application level of 4.3% of the dry mass of the strands. The core strands were further treated with water at an application level of 2.0% of the dry mass of the strands. The treated core layer strands were then removed from the blender.

Additional wooden strands (0.025-0.045 inches thick, 0.25-1.5 inches wide, 0.25-5.0 inches long, about 80% aspen and 20% black poplar) were designated as ‘surface layer’ strands and were dried to a moisture content of about 3-4%. The strands were then transferred into the blender compartment.

An alpha olefin with a molecular weight greater than about 420 Da, known as AlphaPlus C30+ (manufactured by Chevron Phillips Chemical Company, Baytown, Tex.), was heated to a temperature of 107° C. and sprayed onto the surface strands at an application level of 0.5% of the dry mass of the strands. A phenol-formaldehyde type bonding resin, known as WE1029 (manufactured by Hexion Specialty Chemicals, Columbus, Ohio) was sprayed onto the surface strands at an application level of 5.5% of the dry mass of the strands. The treated surface layer strands were then removed from the blender.

The treated strands were formed on top of an ⅛″ aluminum caul plate and a stainless-steel screen into a three-layered mat (24″ long×24″ wide) that was comprised of a bottom layer, a core layer and a top layer. The mass ratio of the outer layers to the core layer was 52:48. The strands in the top and bottom layers were generally oriented parallel to the length of the mat. The strands in the core layer were generally oriented parallel to the width of the mat. The thickness of the mat was about 5 inches and the wet mass was about 12,000 g.

The mat, as well as the underlying caul plate and screen (screen was in direct contact with the bottom of the mat), were transferred into a lab-scale, single-opening hot-press. The platens in the press had a length of 24″ and a width of 24″. The surface of the platens prior to pressing were maintained at a temperature of about 210° C. The press was immediately closed until the gap between the top and bottom platens was 0.719 inches. The closing step occurred over a 30 second period. The distance between the top and bottom platens was maintained at a distance of 0.719 inches for a period of 160 s. The gap between the top and bottom platens was then increased to 0.780 inches over a 61 second period. The press was then rapidly opened and the resulting oriented strand board panel was removed from the press and transferred into a ventilated oven at a temperature of 80° C. for a period of 24 hours. The panel was then removed from the oven and placed into a conditioning chamber (50% R. H., 20° C.) for a period of at least 5 days.

Six replicate panels were made in this manner. Test specimens (1″×1″, 6 count) for a soak test were cut from each panel. Additional test specimens (2″×2″, 4 count) for a dry, non-cycled, internal bond strength test (ASTM D1037) were cut from each panel.

For the soak test each specimen was initially measured for mass, width, length and thickness. All caliper measurements were made in the center of the targeted specimen surface with a Mitutoyo ID F150E Digimatic Indicator, which was equipped with a 0.5″ diameter measurement disk. Specimens were then loaded into cages in order to ensure that they were maintained in a horizontal orientation and were then submerged in water at a temperature of 20° C. such that the top of each specimen was about 1.6 inches under the surface of the water. Each specimen was submerged in the water under these conditions for a period of 7 hours and was then removed from the water and measured for mass and thickness. Based on these measurements, calculations were made regarding the water absorption and thickness swell that had occurred during the 7-hour soaking period. In general, the following equations were used for the calculations:

Water Absorption (%)=100% [(wet specimen mass)−(initial specimen mass)]/[(initial specimen mass)]

Thickness Swell (%)=100% [(wet specimen thickness)−(initial specimen thickness)]/[(initial specimen thickness)]

The results are summarized in Table 6. In this table the individual values for replicate test specimens within a panel have been averaged together.

TABLE 6
Test Values for Oriented Strand Board Made with an Alpha Olefin
having a Molecular Weight Greater than about 420 Da

| | | | INTERNAL |
|---|---|---|---|
| | WATER | THICKNESS | BOND |
| | ABSORPTION (%) | SWELL (%) | STRENGTH |
| PANEL | IN 7 HOURS | IN 7 HOURS | (PSI) |
| 1 | 57.0 | 14.0 | 38.4 |
| 2 | 53.2 | 15.7 | 31.7 |
| 3 | 58.1 | 14.9 | 47.2 |
| 4 | 54.5 | 15.2 | 49.4 |
| 5 | 56.6 | 14.9 | 41.2 |
| 6 | 59.9 | 17.7 | 49.4 |
| AVERAGE | 56.6 | 15.4 | 42.9 |

### Example 7

Oriented strand board was produced in the laboratory with a 50/50 mixture of an ester and an alpha olefin having a molecular weight range of about 280-364 Da.

A 4-Liter glass beaker was charged with a hydrogenated soybean oil, known as 885820 (manufactured by Archer Daniels Midland, Mankato, Minn.) (1,000 g) and an alpha olefin having a molecular weight range of about 280-364 Da, known as Neodene 26+ (manufactured by the Shell Oil Company, New Orleans, La.) (1,000 g). The contents of the beaker were heated by use of a hot plate and were gently stirred to form a low viscosity, single-phase liquid with a faint yellow tint. This mixture was cooled, which resulted in solidification (white, waxy solid), and was then stored until used to make laboratory-scale OSB. This substance was referred to as “Blend #4”.

Wooden strands (0.025-0.045 inches thick, 0.25-1.5 inches wide, 0.25-5.0 inches long, about 80% aspen and 20% black poplar) were designated as ‘core layer’ strands and were dried to a moisture content of about 3-4%. The strands were then transferred into a front-load, cylindrically-shaped, rotating blender compartment (2 feet deep and 6 feet in diameter). The axis of rotation was parallel to the laboratory floor. The rotating interior surface of the compartment was equipped with an array of protruding pegs (2 inches in length and 0.25 inches in diameter), which were effective at catching strands during rotation and carrying them to the upper region of the compartment. The rotation rate of the blender was 11 rpm. In conjunction with the pegs, this rate of rotation resulted in strands being carried to a top region of the blender and then falling to the bottom in a continuous, waterfall-like action. The blender was further equipped with spray nozzles that dispensed bonding resins and waxes into the falling strands at predetermined dosage application levels.

Blend #4 was heated to a temperature of 107° C. and sprayed onto the core strands at an application level of 0.5% of the dry mass of the strands. An isocyanate type bonding resin, known as M20FB (manufactured by the BASF Corporation, Wyandotte, Mich.) was sprayed onto the core strands at an application level of 4.3% of the dry mass of the strands. The core strands were further treated with water at an application level of 2.0% of the dry mass of the strands. The treated core layer strands were then removed from the blender.

Additional wooden strands (0.025-0.045 inches thick, 0.25-1.5 inches wide, 0.25-5.0 inches long, about 80% aspen and 20% black poplar) were designated as ‘surface layer’ strands and were dried to a moisture content of about 3-4%. The strands were then transferred into the blender compartment.

Blend #4 was heated to a temperature of 107° C. and sprayed onto the surface strands at an application level of 0.5% of the dry mass of the strands. A phenol-formaldehyde type bonding resin, known as WE1029 (manufactured by Hexion Specialty Chemicals, Columbus, Ohio) was sprayed onto the surface strands at an application level of 5.5% of the dry mass of the strands. The treated surface layer strands were then removed from the blender.

The treated strands were formed on top of an ⅛″ aluminum caul plate and a stainless-steel screen into a three-layered mat (24″ long×24″ wide) that was comprised of a bottom layer, a core layer and a top layer. The mass ratio of the outer layers to the core layer was 52:48. The strands in the top and bottom layers were generally oriented parallel to the length of the mat. The strands in the core layer were generally oriented parallel to the width of the mat. The thickness of the mat was about 5 inches and the wet mass was about 12,000 g.

The mat, as well as the underlying caul plate and screen (screen was in direct contact with the bottom of the mat), were transferred into a lab-scale, single-opening hot-press. The platens in the press had a length of 24″ and a width of 24″. The surface of the platens prior to pressing were maintained at a temperature of about 210° C. The press was immediately closed until the gap between the top and bottom platens was 0.719 inches. The closing step occurred over a 30 second period. The distance between the top and bottom platens was maintained at a distance of 0.719 inches for a period of 160 s. The gap between the top and bottom platens was then increased to 0.780 inches over a 61 second period. The press was then rapidly opened and the resulting oriented strand board panel was removed from the press and transferred into a ventilated oven at a temperature of 80° C. for a period of 24 hours. The panel was then removed from the oven and placed into a conditioning chamber (50% R.H., 20° C.) for a period of at least 5 days.

Six replicate panels were made in this manner. Test specimens (1″×1″, 6 count) for a soak test were cut from each panel. Additional test specimens (2″×2″, 4 count) for a dry, non-cycled, internal bond strength test (ASTM D1037) were cut from each panel.

For the soak test each specimen was initially measured for mass, width, length and thickness. All caliper measurements were made in the center of the targeted specimen surface with a Mitutoyo ID F150E Digimatic Indicator, which was equipped with a 0.5″ diameter measurement disk. Specimens were then loaded into cages in order to ensure that they were maintained in a horizontal orientation and were then submerged in water at a temperature of 20° C. such that the top of each specimen was about 1.6 inches under the surface of the water. Each specimen was submerged in the water under these conditions for a period of 7 hours and was then removed from the water and measured for mass and thickness. Based on these measurements, calculations were made regarding the water absorption and thickness swell that had occurred during the 7-hour soaking period. In general, the following equations were used for the calculations:

Water Absorption (%)=100% [(wet specimen mass)−(initial specimen mass)]/[(initial specimen mass)]

Thickness Swell (%)=100% [(wet specimen thickness)−(initial specimen thickness)]/[(initial specimen thickness)]

The results are summarized in Table 7. In this table the individual values for replicate test specimens within a panel have been averaged together.

TABLE 7
Test Values for Oriented Strand Board Made with a
50/50 Mixture of an Ester and an Alpha Olefin having
a Molecular Weight Range of about 280-364 Da

| | | | INTERNAL |
|---|---|---|---|
| | WATER | THICKNESS | BOND |
| | ABSORPTION (%) | SWELL (%) | STRENGTH |
| PANEL | IN 7 HOURS | IN 7 HOURS | (PSI) |
| 1 | 53.2 | 14.5 | 71.7 |
| 2 | 56.4 | 14.7 | 48.7 |
| 3 | 54.2 | 15.3 | 53.6 |
| 4 | 56.2 | 16.5 | 32.7 |
| 5 | 53.9 | 15.8 | 55.2 |
| 6 | 54.8 | 15.6 | 52.1 |
| AVERAGE | 54.8 | 15.4 | 52.3 |

### Example 8

Oriented strand board was produced in the laboratory with a 60/40 mixture of an ester and an alpha olefin having a molecular weight range of about 280-364 Da.

A 4-Liter glass beaker was charged with a hydrogenated soybean oil, known as 885820 (manufactured by Archer Daniels Midland, Mankato, Minn.) (1,200 g) and an alpha olefin having a molecular weight range of about 280-364 Da, known as Neodene 26+ (manufactured by the Shell Oil Company, New Orleans, La.) (800 g). The contents of the beaker were heated by use of a hot plate and were gently stirred to form a low viscosity, single-phase liquid with a faint yellow tint. This mixture was cooled, which resulted in solidification (white, waxy solid), and was then stored until used to make laboratory-scale OSB. This substance was referred to as “Blend #5”.

Wooden strands (0.025-0.045 inches thick, 0.25-1.5 inches wide, 0.25-5.0 inches long, about 80% aspen and 20% black poplar) were designated as ‘core layer’ strands and were dried to a moisture content of about 3-4%. The strands were then transferred into a front-load, cylindrically-shaped, rotating blender compartment (2 feet deep and 6 feet in diameter). The axis of rotation was parallel to the laboratory floor. The rotating interior surface of the compartment was equipped with an array of protruding pegs (2 inches in length and 0.25 inches in diameter), which were effective at catching strands during rotation and carrying them to the upper region of the compartment. The rotation rate of the blender was 11 rpm. In conjunction with the pegs, this rate of rotation resulted in strands being carried to a top region of the blender and then falling to the bottom in a continuous, waterfall-like action. The blender was further equipped with spray nozzles that dispensed bonding resins and waxes into the falling strands at predetermined dosage application levels.

Blend #5 was heated to a temperature of 107° C. and sprayed onto the core strands at an application level of 0.5% of the dry mass of the strands. An isocyanate type bonding resin, known as M20FB (manufactured by the BASF Corporation, Wyandotte, Mich.) was sprayed onto the core strands at an application level of 4.3% of the dry mass of the strands. The core strands were further treated with water at an application level of 2.0% of the dry mass of the strands. The treated core layer strands were then removed from the blender.

Additional wooden strands (0.025-0.045 inches thick, 0.25-1.5 inches wide, 0.25-5.0 inches long, about 80% aspen and 20% black poplar) were designated as ‘surface layer’ strands and were dried to a moisture content of about 3-4%. The strands were then transferred into the blender compartment.

Blend #5 was heated to a temperature of 107° C. and sprayed onto the surface strands at an application level of 0.5% of the dry mass of the strands. A phenol-formaldehyde type bonding resin, known as WE1029 (manufactured by Hexion Specialty Chemicals, Columbus, Ohio) was sprayed onto the surface strands at an application level of 5.5% of the dry mass of the strands. The treated surface layer strands were then removed from the blender.

The treated strands were formed on top of an ⅛″ aluminum caul plate and a stainless-steel screen into a three-layered mat (24″ long×24″ wide) that was comprised of a bottom layer, a core layer and a top layer. The mass ratio of the outer layers to the core layer was 52:48. The strands in the top and bottom layers were generally oriented parallel to the length of the mat. The strands in the core layer were generally oriented parallel to the width of the mat. The thickness of the mat was about 5 inches and the wet mass was about 12,000 g.

The mat, as well as the underlying caul plate and screen (screen was in direct contact with the bottom of the mat), were transferred into a lab-scale, single-opening hot-press. The platens in the press had a length of 24″ and a width of 24″. The surface of the platens prior to pressing were maintained at a temperature of about 210° C. The press was immediately closed until the gap between the top and bottom platens was 0.719 inches. The closing step occurred over a 30 second period. The distance between the top and bottom platens was maintained at a distance of 0.719 inches for a period of 160 s. The gap between the top and bottom platens was then increased to 0.780 inches over a 61 second period. The press was then rapidly opened and the resulting oriented strand board panel was removed from the press and transferred into a ventilated oven at a temperature of 80° C. for a period of 24 hours. The panel was then removed from the oven and placed into a conditioning chamber (50% R.H., 20° C.) for a period of at least 5 days.

Six replicate panels were made in this manner. Test specimens (1″×1″, 6 count) for a soak test were cut from each panel. Additional test specimens (2″×2″, 4 count) for a dry, non-cycled, internal bond strength test (ASTM D1037) were cut from each panel.

For the soak test each specimen was initially measured for mass, width, length and thickness. All caliper measurements were made in the center of the targeted specimen surface with a Mitutoyo ID F150E Digimatic Indicator, which was equipped with a 0.5″ diameter measurement disk. Specimens were then loaded into cages in order to ensure that they were maintained in a horizontal orientation and were then submerged in water at a temperature of 20° C. such that the top of each specimen was about 1.6 inches under the surface of the water. Each specimen was submerged in the water under these conditions for a period of 7 hours and was then removed from the water and measured for mass and thickness. Based on these measurements, calculations were made regarding the water absorption and thickness swell that had occurred during the 7-hour soaking period. In general, the following equations were used for the calculations:

Water Absorption (%)=100% [(wet specimen mass)−(initial specimen mass)]/[(initial specimen mass)]

Thickness Swell (%)=100% [(wet specimen thickness)−(initial specimen thickness)]/[(initial specimen thickness)]

The results are summarized in Table 8. In this table the individual values for replicate test specimens within a panel have been averaged together.

TABLE 8
Test Values for Oriented Strand Board Made with a
60/40 Mixture of an Ester and an Alpha Olefin having
a Molecular Weight Range of about 280-364 Da

| | | | INTERNAL |
|---|---|---|---|
| | WATER | THICKNESS | BOND |
| | ABSORPTION (%) | SWELL (%) | STRENGTH |
| PANEL | IN 7 HOURS | IN 7 HOURS | (PSI) |
| 1 | 55.8 | 17.4 | 77.8 |
| 2 | 58.4 | 14.9 | 47.1 |
| 3 | 59.3 | 15.9 | 45.1 |
| 4 | 62.3 | 17.0 | 46.8 |
| 5 | 60.3 | 17.3 | 33.7 |
| 6 | 62.9 | 16.7 | 51.9 |
| AVERAGE | 59.8 | 16.5 | 50.4 |

### Example 9

Oriented strand board was produced in the laboratory with a 70/30 mixture of an ester and an alpha olefin having a molecular weight range of about 280-364 Da.

A 4-Liter glass beaker was charged with a hydrogenated soybean oil, known as 885820 (manufactured by Archer Daniels Midland, Mankato, Minn.) (1,400 g) and an alpha olefin having a molecular weight range of about 280-364 Da, known as Neodene 26+ (manufactured by the Shell Oil Company, New Orleans, La.) (600 g). The contents of the beaker were heated by use of a hot plate and were gently stirred to form a low viscosity, single-phase liquid with a faint yellow tint. This mixture was cooled, which resulted in solidification (white, waxy solid), and was then stored until used to make laboratory-scale OSB. This substance was referred to as “Blend #6”.

Wooden strands (0.025-0.045 inches thick, 0.25-1.5 inches wide, 0.25-5.0 inches long, about 80% aspen and 20% black poplar) were designated as ‘core layer’ strands and were dried to a moisture content of about 3-4%. The strands were then transferred into a front-load, cylindrically-shaped, rotating blender compartment (2 feet deep and 6 feet in diameter). The axis of rotation was parallel to the laboratory floor. The rotating interior surface of the compartment was equipped with an array of protruding pegs (2 inches in length and 0.25 inches in diameter), which were effective at catching strands during rotation and carrying them to the upper region of the compartment. The rotation rate of the blender was 11 rpm. In conjunction with the pegs, this rate of rotation resulted in strands being carried to a top region of the blender and then falling to the bottom in a continuous, waterfall-like action. The blender was further equipped with spray nozzles that dispensed bonding resins and waxes into the falling strands at predetermined dosage application levels.

Blend #6 was heated to a temperature of 107° C. and sprayed onto the core strands at an application level of 0.5% of the dry mass of the strands. An isocyanate type bonding resin, known as M20FB (manufactured by the BASF Corporation, Wyandotte, Mich.) was sprayed onto the core strands at an application level of 4.3% of the dry mass of the strands. The core strands were further treated with water at an application level of 2.0% of the dry mass of the strands. The treated core layer strands were then removed from the blender.

Additional wooden strands (0.025-0.045 inches thick, 0.25-1.5 inches wide, 0.25-5.0 inches long, about 80% aspen and 20% black poplar) were designated as ‘surface layer’ strands and were dried to a moisture content of about 3-4%. The strands were then transferred into the blender compartment.

Blend #6 was heated to a temperature of 107° C. and sprayed onto the surface strands at an application level of 0.5% of the dry mass of the strands. A phenol-formaldehyde type bonding resin, known as WE1029 (manufactured by Hexion Specialty Chemicals, Columbus, Ohio) was sprayed onto the surface strands at an application level of 5.5% of the dry mass of the strands. The treated surface layer strands were then removed from the blender.

The treated strands were formed on top of an ⅛″ aluminum caul plate and a stainless-steel screen into a three-layered mat (24″ long×24″ wide) that was comprised of a bottom layer, a core layer and a top layer. The mass ratio of the outer layers to the core layer was 52:48. The strands in the top and bottom layers were generally oriented parallel to the length of the mat. The strands in the core layer were generally oriented parallel to the width of the mat. The thickness of the mat was about 5 inches and the wet mass was about 12,000 g.

The mat, as well as the underlying caul plate and screen (screen was in direct contact with the bottom of the mat), were transferred into a lab-scale, single-opening hot-press. The platens in the press had a length of 24″ and a width of 24″. The surface of the platens prior to pressing were maintained at a temperature of about 210° C. The press was immediately closed until the gap between the top and bottom platens was 0.719 inches. The closing step occurred over a 30 second period. The distance between the top and bottom platens was maintained at a distance of 0.719 inches for a period of 160 s. The gap between the top and bottom platens was then increased to 0.780 inches over a 61 second period. The press was then rapidly opened and the resulting oriented strand board panel was removed from the press and transferred into a ventilated oven at a temperature of 80° C. for a period of 24 hours. The panel was then removed from the oven and placed into a conditioning chamber (50% R.H., 20° C.) for a period of at least 5 days.

Six replicate panels were made in this manner. Test specimens (1″×1″, 6 count) for a soak test were cut from each panel. Additional test specimens (2″×2″, 4 count) for a dry, non-cycled, internal bond strength test (ASTM D1037) were cut from each panel.

For the soak test each specimen was initially measured for mass, width, length and thickness. All caliper measurements were made in the center of the targeted specimen surface with a Mitutoyo ID F150E Digimatic Indicator, which was equipped with a 0.5″ diameter measurement disk. Specimens were then loaded into cages in order to ensure that they were maintained in a horizontal orientation and were then submerged in water at a temperature of 20° C. such that the top of each specimen was about 1.6 inches under the surface of the water. Each specimen was submerged in the water under these conditions for a period of 7 hours and was then removed from the water and measured for mass and thickness. Based on these measurements, calculations were made regarding the water absorption and thickness swell that had occurred during the 7-hour soaking period. In general, the following equations were used for the calculations:

Water Absorption (%)=100% [(wet specimen mass)−(initial specimen mass)]/[(initial specimen mass)]

Thickness Swell (%)=100% [(wet specimen thickness)−(initial specimen thickness)]/[(initial specimen thickness)]

The results are summarized in Table 9. In this table the individual values for replicate test specimens within a panel have been averaged together.

TABLE 9
Test Values for Oriented Strand Board Made with a
70/30 Mixture of an Ester and an Alpha Olefin having
a Molecular Weight Range of about 280-364 Da

| | | | INTERNAL |
|---|---|---|---|
| | WATER | THICKNESS | BOND |
| | ABSORPTION (%) | SWELL (%) | STRENGTH |
| PANEL | IN 7 HOURS | IN 7 HOURS | (PSI) |
| 1 | 60.2 | 19.2 | 52.1 |
| 2 | 64.8 | 20.0 | 24.4 |
| 3 | 64.3 | 18.1 | 56.3 |
| 4 | 60.1 | 15.9 | 49.3 |
| 5 | 63.6 | 16.3 | 49.6 |
| 6 | 58.9 | 16.5 | 56.6 |
| AVERAGE | 62.0 | 17.7 | 48.1 |

### Example 10

Wax-free oriented strand board was produced in the laboratory in the following manner. Wooden strands (0.025-0.045 inches thick, 0.25-1.5 inches wide, 0.25-5.0 inches long, about 80% aspen and 20% black poplar) were designated as ‘core layer’ strands and were dried to a moisture content of about 3-4%. The strands were then transferred into a front-load, cylindrically-shaped, rotating blender compartment (2 feet deep and 6 feet in diameter). The axis of rotation was parallel to the laboratory floor. The rotating interior surface of the compartment was equipped with an array of protruding pegs (2 inches in length and 0.25 inches in diameter), which were effective at catching strands during rotation and carrying them to the upper region of the compartment. The rotation rate of the blender was 11 rpm. In conjunction with the pegs, this rate of rotation resulted in strands being carried to a top region of the blender and then falling to the bottom in a continuous, waterfall-like action. The blender was further equipped with spray nozzles that dispensed bonding resins and waxes into the falling strands at predetermined dosage application levels.

An isocyanate type bonding resin, known as M20FB (manufactured by the BASF Corporation, Wyandotte, Mich.) was sprayed onto the core strands at an application level of 4.3% of the dry mass of the strands. The strands were further treated with water at an application level of 2.0% of the dry mass of the strands. The treated core layer strands were then removed from the blender.

Additional wooden strands (0.025-0.045 inches thick, 0.25-1.5 inches wide, 0.25-5.0 inches long, about 80% aspen and 20% black poplar) were designated as ‘surface layer’ strands and were dried to a moisture content of about 3-4%. The strands were then transferred into the blender compartment.

A phenol-formaldehyde type bonding resin, known as WE1029 (manufactured by Hexion Specialty Chemicals, Columbus, Ohio) was sprayed onto the surface strands at an application level of 5.5% of the dry mass of the strands. The treated surface layer strands were then removed from the blender.

The treated strands were formed on top of an ⅛″ aluminum caul plate and a stainless-steel screen into a three-layered mat (24″ long×24″ wide) that was comprised of a bottom layer, a core layer and a top layer. The mass ratio of the outer layers to the core layer was 52:48. The strands in the top and bottom layers were generally oriented parallel to the length of the mat. The strands in the core layer were generally oriented parallel to the width of the mat. The thickness of the mat was about 5 inches and the wet mass was about 12,000 g.

The mat, as well as the underlying caul plate and screen (screen was in direct contact with the bottom of the mat), were transferred into a lab-scale, single-opening hot-press. The platens in the press had a length of 24″ and a width of 24″. The surface of the platens prior to pressing were maintained at a temperature of about 210° C. The press was immediately closed until the gap between the top and bottom platens was 0.719 inches. The closing step occurred over a 30 second period. The distance between the top and bottom platens was maintained at a distance of 0.719 inches for a period of 160 s. The gap between the top and bottom platens was then increased to 0.780 inches over a 61 second period. The press was then rapidly opened and the resulting oriented strand board panel was removed from the press and transferred into a ventilated oven at a temperature of 80° C. for a period of 24 hours. The panel was then removed from the oven and placed into a conditioning chamber (50% R.H., 20° C.) for a period of at least 5 days.

Six replicate panels were made in this manner. Test specimens (1″×1″, 6 count) for a soak test were cut from each panel. Additional test specimens (2″×2″, 4 count) for a dry, non-cycled, internal bond strength test (ASTM D1037) were cut from each panel.

For the soak test each specimen was initially measured for mass, width, length and thickness. All caliper measurements were made in the center of the targeted specimen surface with a Mitutoyo ID F150E Digimatic Indicator, which was equipped with a 0.5″ diameter measurement disk. Specimens were then loaded into cages in order to ensure that they were maintained in a horizontal orientation and were then submerged in water at a temperature of 20° C. such that the top of each specimen was about 1.6 inches under the surface of the water. Each specimen was submerged in the water under these conditions for a period of 7 hours and was then removed from the water and measured for mass and thickness. Based on these measurements, calculations were made regarding the water absorption and thickness swell that had occurred during the 7-hour soaking period. In general, the following equations were used for the calculations:

Water Absorption (%)=100% [(wet specimen mass)−(initial specimen mass)]/[(initial specimen mass)]

Thickness Swell (%)=100% [(wet specimen thickness)−(initial specimen thickness)]/[(initial specimen thickness)]

The results are summarized in Table 10. In this table the individual values for replicate test specimens within a panel have been averaged together.

TABLE 10
Test Values for Oriented Strand Board Made with No Wax

| | | | INTERNAL |
|---|---|---|---|
| | WATER | THICKNESS | BOND |
| | ABSORPTION (%) | SWELL (%) | STRENGTH |
| PANEL | IN 7 HOURS | IN 7 HOURS | (PSI) |
| 1 | 87.1 | 22.1 | 30.8 |
| 2 | 86.5 | 22.3 | 56.4 |
| 3 | 83.9 | 23.4 | 55.9 |
| 4 | 85.4 | 21.0 | 53.6 |
| 5 | 77.2 | 23.2 | 69.4 |
| 6 | 87.9 | 20.0 | 53.5 |
| AVERAGE | 84.7 | 22.0 | 53.3 |

### Example 11

Oriented strand board was produced in the laboratory with a first conventional petroleum-based slack wax in the following manner. Wooden strands (0.025-0.045 inches thick, 0.25-1.5 inches wide, 0.25-5.0 inches long, about 80% aspen and 20% black poplar) were designated as ‘core layer’ strands and were dried to a moisture content of about 3-4%. The strands were then transferred into a front-load, cylindrically-shaped, rotating blender compartment (2 feet deep and 6 feet in diameter). The axis of rotation was parallel to the laboratory floor. The rotating interior surface of the compartment was equipped with an array of protruding pegs (2 inches in length and 0.25 inches in diameter), which were effective at catching strands during rotation and carrying them to the upper region of the compartment. The rotation rate of the blender was 11 rpm. In conjunction with the pegs, this rate of rotation resulted in strands being carried to a top region of the blender and then falling to the bottom in a continuous, waterfall-like action. The blender was further equipped with spray nozzles that dispensed bonding resins and waxes into the falling strands at predetermined dosage application levels.

A conventional petroleum-based slack wax, known as 431B (manufactured by the International Group Incorporated, Toronto, ON), was heated to a temperature of 107° C. and sprayed onto the core strands at an application level of 0.5% of the dry mass of the strands. An isocyanate type bonding resin, known as M20FB (manufactured by the BASF Corporation, Wyandotte, Mich.) was sprayed onto the core strands at an application level of 4.3% of the dry mass of the strands. The core strands were further treated with water at an application level of 2.0% of the dry mass of the strands. The treated core layer strands were then removed from the blender.

Additional wooden strands (0.025-0.045 inches thick, 0.25-1.5 inches wide, 0.25-5.0 inches long, about 80% aspen and 20% black poplar) were designated as ‘surface layer’ strands and were dried to a moisture content of about 3-4%. The strands were then transferred into the blender compartment.

A conventional petroleum-based slack wax, known as 431B (manufactured by the International Group Incorporated, Toronto, ON), was heated to a temperature of 107° C. and sprayed onto the surface strands at an application level of 0.5% of the dry mass of the strands. A phenol-formaldehyde type bonding resin, known as WE1029 (manufactured by Hexion Specialty Chemicals, Columbus, Ohio) was sprayed onto the surface strands at an application level of 5.5% of the dry mass of the strands. The treated surface layer strands were then removed from the blender.

The treated strands were formed on top of an ⅛″ aluminum caul plate and a stainless-steel screen into a three-layered mat (24″ long×24″ wide) that was comprised of a bottom layer, a core layer and a top layer. The mass ratio of the outer layers to the core layer was 52:48. The strands in the top and bottom layers were generally oriented parallel to the length of the mat. The strands in the core layer were generally oriented parallel to the width of the mat. The thickness of the mat was about 5 inches and the wet mass was about 12,000 g.

The mat, as well as the underlying caul plate and screen (screen was in direct contact with the bottom of the mat), were transferred into a lab-scale, single-opening hot-press. The platens in the press had a length of 24″ and a width of 24″. The surface of the platens prior to pressing were maintained at a temperature of about 210° C. The press was immediately closed until the gap between the top and bottom platens was 0.719 inches. The closing step occurred over a 30 second period. The distance between the top and bottom platens was maintained at a distance of 0.719 inches for a period of 160 s. The gap between the top and bottom platens was then increased to 0.780 inches over a 61 second period. The press was then rapidly opened and the resulting oriented strand board panel was removed from the press and transferred into a ventilated oven at a temperature of 80° C. for a period of 24 hours. The panel was then removed from the oven and placed into a conditioning chamber (50% R.H., 20° C.) for a period of at least 5 days.

Six replicate panels were made in this manner. Test specimens (1″×1″, 6 count) for a soak test were cut from each panel. Additional test specimens (2″×2″, 4 count) for a dry, non-cycled, internal bond strength test (ASTM D1037) were cut from each panel.

For the soak test each specimen was initially measured for mass, width, length and thickness. All caliper measurements were made in the center of the targeted specimen surface with a Mitutoyo ID F150E Digimatic Indicator, which was equipped with a 0.5″ diameter measurement disk. Specimens were then loaded into cages in order to ensure that they were maintained in a horizontal orientation and were then submerged in water at a temperature of 20° C. such that the top of each specimen was about 1.6 inches under the surface of the water. Each specimen was submerged in the water under these conditions for a period of 7 hours and was then removed from the water and measured for mass and thickness. Based on these measurements, calculations were made regarding the water absorption and thickness swell that had occurred during the 7-hour soaking period. In general, the following equations were used for the calculations:

Water Absorption (%)=100% [(wet specimen mass)−(initial specimen mass)]/[(initial specimen mass)]

Thickness Swell (%)=100% [(wet specimen thickness)−(initial specimen thickness)]/[(initial specimen thickness)]

The results are summarized in Table 11. In this table the individual values for replicate test specimens within a panel have been averaged together.

TABLE 11
Test Values for Oriented Strand Board Made with a
First Conventional Petroleum-Based Slack Wax (431B)

| | | | INTERNAL |
|---|---|---|---|
| | WATER | THICKNESS | BOND |
| | ABSORPTION (%) | SWELL (%) | STRENGTH |
| PANEL | IN 7 HOURS | IN 7 HOURS | (PSI) |
| 1 | 57.4 | 16.7 | 52.9 |
| 2 | 59.0 | 15.9 | 43.0 |
| 3 | 57.0 | 17.8 | 51.9 |
| 4 | 56.0 | 16.9 | 45.8 |
| 5 | 57.3 | 15.4 | 47.7 |
| 6 | 51.1 | 15.1 | 58.4 |
| AVERAGE | 56.3 | 16.3 | 50.0 |

### Example 12

Oriented strand board was produced in the laboratory with a second conventional petroleum-based slack wax in the following manner. Wooden strands (0.025-0.045 inches thick, 0.25-1.5 inches wide, 0.25-5.0 inches long, about 80% aspen and 20% black poplar) were designated as ‘core layer’ strands and were dried to a moisture content of about 3-4%. The strands were then transferred into a front-load, cylindrically-shaped, rotating blender compartment (2 feet deep and 6 feet in diameter). The axis of rotation was parallel to the laboratory floor. The rotating interior surface of the compartment was equipped with an array of protruding pegs (2 inches in length and 0.25 inches in diameter), which were effective at catching strands during rotation and carrying them to the upper region of the compartment. The rotation rate of the blender was 11 rpm. In conjunction with the pegs, this rate of rotation resulted in strands being carried to a top region of the blender and then falling to the bottom in a continuous, waterfall-like action. The blender was further equipped with spray nozzles that dispensed bonding resins and waxes into the falling strands at predetermined dosage application levels.

A conventional petroleum-based slack wax, known as ProWax 561 (manufactured by the ExxonMobil Corporation, Baytown, Tex.), was heated to a temperature of 107° C. and sprayed onto the core strands at an application level of 0.5% of the dry mass of the strands. An isocyanate type bonding resin, known as M20FB (manufactured by the BASF Corporation, Wyandotte, Mich.) was sprayed onto the core strands at an application level of 4.3% of the dry mass of the strands. The core strands were further treated with water at an application level of 2.0% of the dry mass of the strands. The treated core layer strands were then removed from the blender.

Additional wooden strands (0.025-0.045 inches thick, 0.25-1.5 inches wide, 0.25-5.0 inches long, about 80% aspen and 20% black poplar) were designated as ‘surface layer’ strands and were dried to a moisture content of about 3-4%. The strands were then transferred into the blender compartment.

A conventional petroleum-based slack wax, known as ProWax 561 (manufactured by the ExxonMobil Corporation, Baytown, Tex.), was heated to a temperature of 107° C. and sprayed onto the surface strands at an application level of 0.5% of the dry mass of the strands. A phenol-formaldehyde type bonding resin, known as WE1029 (manufactured by Hexion Specialty Chemicals, Columbus, Ohio) was sprayed onto the surface strands at an application level of 5.5% of the dry mass of the strands. The treated surface layer strands were then removed from the blender.

The treated strands were formed on top of an ⅛″ aluminum caul plate and a stainless-steel screen into a three-layered mat (24″ long×24″ wide) that was comprised of a bottom layer, a core layer and a top layer. The mass ratio of the outer layers to the core layer was 52:48. The strands in the top and bottom layers were generally oriented parallel to the length of the mat. The strands in the core layer were generally oriented parallel to the width of the mat. The thickness of the mat was about 5 inches and the wet mass was about 12,000 g.

The mat, as well as the underlying caul plate and screen (screen was in direct contact with the bottom of the mat), were transferred into a lab-scale, single-opening hot-press. The platens in the press had a length of 24″ and a width of 24″. The surface of the platens prior to pressing were maintained at a temperature of about 210° C. The press was immediately closed until the gap between the top and bottom platens was 0.719 inches. The closing step occurred over a 30 second period. The distance between the top and bottom platens was maintained at a distance of 0.719 inches for a period of 160 s. The gap between the top and bottom platens was then increased to 0.780 inches over a 61 second period. The press was then rapidly opened and the resulting oriented strand board panel was removed from the press and transferred into a ventilated oven at a temperature of 80° C. for a period of 24 hours. The panel was then removed from the oven and placed into a conditioning chamber (50% R.H., 20° C.) for a period of at least 5 days.

Six replicate panels were made in this manner. Test specimens (1″×1″, 6 count) for a soak test were cut from each panel. Additional test specimens (2″×2″, 4 count) for a dry, non-cycled, internal bond strength test (ASTM D1037) were cut from each panel.

For the soak test each specimen was initially measured for mass, width, length and thickness. All caliper measurements were made in the center of the targeted specimen surface with a Mitutoyo ID F150E Digimatic Indicator, which was equipped with a 0.5″ diameter measurement disk. Specimens were then loaded into cages in order to ensure that they were maintained in a horizontal orientation and were then submerged in water at a temperature of 20° C. such that the top of each specimen was about 1.6 inches under the surface of the water. Each specimen was submerged in the water under these conditions for a period of 7 hours and was then removed from the water and measured for mass and thickness. Based on these measurements, calculations were made regarding the water absorption and thickness swell that had occurred during the 7-hour soaking period. In general, the following equations were used for the calculations:

Water Absorption (%)=100% [(wet specimen mass)−(initial specimen mass)]/[(initial specimen mass)]

Thickness Swell (%)=100% [(wet specimen thickness)−(initial specimen thickness)]/[(initial specimen thickness)]

The results are summarized in Table 12. In this table the individual values for replicate test specimens within a panel have been averaged together.

TABLE 12
Test Values for Oriented Strand Board Made with a Second
Conventional Petroleum-Based Slack Wax (ProWax 561)

| | | | INTERNAL |
|---|---|---|---|
| | WATER | THICKNESS | BOND |
| | ABSORPTION (%) | SWELL (%) | STRENGTH |
| PANEL | IN 7 HOURS | IN 7 HOURS | (PSI) |
| 1 | 56.7 | 14.1 | 50.2 |
| 2 | 52.7 | 13.6 | 46.8 |
| 3 | 62.5 | 15.9 | 49.3 |
| 4 | 51.5 | 15.1 | 50.8 |
| 5 | 52.3 | 15.9 | 47.4 |
| 6 | 55.1 | 15.1 | 48.6 |
| AVERAGE | 55.1 | 15.0 | 48.9 |

### Example 13

Oriented strand board was produced in the laboratory with an ester (hydrogenated soybean oil) wax in the following manner. Wooden strands (0.025-0.045 inches thick, 0.25-1.5 inches wide, 0.25-5.0 inches long, about 80% aspen and 20% black poplar) were designated as ‘core layer’ strands and were dried to a moisture content of about 3-4%. The strands were then transferred into a front-load, cylindrically-shaped, rotating blender compartment (2 feet deep and 6 feet in diameter). The axis of rotation was parallel to the laboratory floor. The rotating interior surface of the compartment was equipped with an array of protruding pegs (2 inches in length and 0.25 inches in diameter), which were effective at catching strands during rotation and carrying them to the upper region of the compartment. The rotation rate of the blender was 11 rpm. In conjunction with the pegs, this rate of rotation resulted in strands being carried to a top region of the blender and then falling to the bottom in a continuous, waterfall-like action. The blender was further equipped with spray nozzles that dispensed bonding resins and waxes into the falling strands at predetermined dosage application levels.

A hydrogenated soybean oil wax, known as 885820 (manufactured by Archer Daniels Midland, Mankato, Minn.), was heated to a temperature of 107° C. and sprayed onto the core strands at an application level of 0.5% of the dry mass of the strands. An isocyanate type bonding resin, known as M20FB (manufactured by the BASF Corporation, Wyandotte, MI) was sprayed onto the core strands at an application level of 4.3% of the dry mass of the strands. The core strands were further treated with water at an application level of 2.0% of the dry mass of the strands. The treated core layer strands were then removed from the blender.

Additional wooden strands (0.025-0.045 inches thick, 0.25-1.5 inches wide, 0.25-5.0 inches long, about 80% aspen and 20% black poplar) were designated as ‘surface layer’ strands and were dried to a moisture content of about 3-4%. The strands were then transferred into the blender compartment.

A hydrogenated soybean oil wax, known as 885820 (manufactured by Archer Daniels Midland, Mankato, Minn.), was heated to a temperature of 107° C. and sprayed onto the surface strands at an application level of 0.5% of the dry mass of the strands. A phenol-formaldehyde type bonding resin, known as WE1029 (manufactured by Hexion Specialty Chemicals, Columbus, Ohio) was sprayed onto the surface strands at an application level of 5.5% of the dry mass of the strands. The treated surface layer strands were then removed from the blender.

The treated strands were formed on top of an ⅛″ aluminum caul plate and a stainless-steel screen into a three-layered mat (24″ long×24″ wide) that was comprised of a bottom layer, a core layer and a top layer. The mass ratio of the outer layers to the core layer was 52:48. The strands in the top and bottom layers were generally oriented parallel to the length of the mat. The strands in the core layer were generally oriented parallel to the width of the mat. The thickness of the mat was about 5 inches and the wet mass was about 12,000 g.

The mat, as well as the underlying caul plate and screen (screen was in direct contact with the bottom of the mat), were transferred into a lab-scale, single-opening hot-press. The platens in the press had a length of 24″ and a width of 24″. The surface of the platens prior to pressing were maintained at a temperature of about 210° C. The press was immediately closed until the gap between the top and bottom platens was 0.719 inches. The closing step occurred over a 30 second period. The distance between the top and bottom platens was maintained at a distance of 0.719 inches for a period of 160 s. The gap between the top and bottom platens was then increased to 0.780 inches over a 61 second period. The press was then rapidly opened and the resulting oriented strand board panel was removed from the press and transferred into a ventilated oven at a temperature of 80° C. for a period of 24 hours. The panel was then removed from the oven and placed into a conditioning chamber (50% R.H., 20° C.) for a period of at least 5 days.

Six replicate panels were made in this manner. Test specimens (1″×1″, 6 count) for a soak test were cut from each panel. Additional test specimens (2″×2″, 4 count) for a dry, non-cycled, internal bond strength test (ASTM D1037) were cut from each panel.

For the soak test each specimen was initially measured for mass, width, length and thickness. All caliper measurements were made in the center of the targeted specimen surface with a Mitutoyo ID F150E Digimatic Indicator, which was equipped with a 0.5″ diameter measurement disk. Specimens were then loaded into cages in order to ensure that they were maintained in a horizontal orientation and were then submerged in water at a temperature of 20° C. such that the top of each specimen was about 1.6 inches under the surface of the water. Each specimen was submerged in the water under these conditions for a period of 7 hours and was then removed from the water and measured for mass and thickness. Based on these measurements, calculations were made regarding the water absorption and thickness swell that had occurred during the 7-hour soaking period. In general, the following equations were used for the calculations:

Water Absorption (%)=100% [(wet specimen mass)−(initial specimen mass)]/[(initial specimen mass)]

Thickness Swell (%)=100% [(wet specimen thickness)−(initial specimen thickness)]/[(initial specimen thickness)]

The results are summarized in Table 13. In this table the individual values for replicate test specimens within a panel have been averaged together.

TABLE 13
Test Values for Oriented Strand Board Made with
an Ester (Hydrogenated Soybean Oil Wax)

| | | | INTERNAL |
|---|---|---|---|
| | WATER | THICKNESS | BOND |
| | ABSORPTION (%) | SWELL (%) | STRENGTH |
| PANEL | IN 7 HOURS | IN 7 HOURS | (PSI) |
| 1 | 75.7 | 20.0 | 57.7 |
| 2 | 73.6 | 19.7 | 59.8 |
| 3 | 77.4 | 18.1 | 44.4 |
| 4 | 70.8 | 21.1 | 56.5 |
| 5 | 73.4 | 19.1 | 55.5 |
| 6 | 76.5 | 19.4 | 49.4 |
| AVERAGE | 74.6 | 19.6 | 53.9 |

### Example 14

Oriented strand board was produced in the laboratory with an ester (hydrogenated tallow) wax in the following manner. Wooden strands (0.025-0.045 inches thick, 0.25-1.5 inches wide, 0.25-5.0 inches long, about 80% aspen and 20% black poplar) were designated as ‘core layer’ strands and were dried to a moisture content of about 3-4%. The strands were then transferred into a front-load, cylindrically-shaped, rotating blender compartment (2 feet deep and 6 feet in diameter). The axis of rotation was parallel to the laboratory floor. The rotating interior surface of the compartment was equipped with an array of protruding pegs (2 inches in length and 0.25 inches in diameter), which were effective at catching strands during rotation and carrying them to the upper region of the compartment. The rotation rate of the blender was 11 rpm. In conjunction with the pegs, this rate of rotation resulted in strands being carried to a top region of the blender and then falling to the bottom in a continuous, waterfall-like action. The blender was further equipped with spray nozzles that dispensed bonding resins and waxes into the falling strands at predetermined dosage application levels.

A hydrogenated tallow wax, known as 135V (manufactured by South Chicago Packing, Chicago, Ill.), was heated to a temperature of 107° C. and sprayed onto the core strands at an application level of 0.5% of the dry mass of the strands. An isocyanate type bonding resin, known as M20FB (manufactured by the BASF Corporation, Wyandotte, Mich.) was sprayed onto the core strands at an application level of 4.3% of the dry mass of the strands. The core strands were further treated with water at an application level of 2.0% of the dry mass of the strands. The treated core layer strands were then removed from the blender.

Additional wooden strands (0.025-0.045 inches thick, 0.25-1.5 inches wide, 0.25-5.0 inches long, about 80% aspen and 20% black poplar) were designated as ‘surface layer’ strands and were dried to a moisture content of about 3-4%. The strands were then transferred into the blender compartment.

A hydrogenated tallow wax, known as 135V (manufactured by South Chicago Packing, Chicago, Ill.), was heated to a temperature of 107° C. and sprayed onto the surface strands at an application level of 0.5% of the dry mass of the strands. A phenol-formaldehyde type bonding resin, known as WE1029 (manufactured by Hexion Specialty Chemicals, Columbus, Ohio) was sprayed onto the surface strands at an application level of 5.5% of the dry mass of the strands. The treated surface layer strands were then removed from the blender.

The treated strands were formed on top of an ⅛″ aluminum caul plate and a stainless-steel screen into a three-layered mat (24″ long×24″ wide) that was comprised of a bottom layer, a core layer and a top layer. The mass ratio of the outer layers to the core layer was 52:48. The strands in the top and bottom layers were generally oriented parallel to the length of the mat. The strands in the core layer were generally oriented parallel to the width of the mat. The thickness of the mat was about 5 inches and the wet mass was about 12,000 g.

The mat, as well as the underlying caul plate and screen (screen was in direct contact with the bottom of the mat), were transferred into a lab-scale, single-opening hot-press. The platens in the press had a length of 24″ and a width of 24″. The surface of the platens prior to pressing were maintained at a temperature of about 210° C. The press was immediately closed until the gap between the top and bottom platens was 0.719 inches. The closing step occurred over a 30 second period. The distance between the top and bottom platens was maintained at a distance of 0.719 inches for a period of 160 s. The gap between the top and bottom platens was then increased to 0.780 inches over a 61 second period. The press was then rapidly opened and the resulting oriented strand board panel was removed from the press and transferred into a ventilated oven at a temperature of 80° C. for a period of 24 hours. The panel was then removed from the oven and placed into a conditioning chamber (50% R.H., 20° C.) for a period of at least 5 days.

Six replicate panels were made in this manner. Test specimens (1″×1″, 6 count) for a soak test were cut from each panel. Additional test specimens (2″×2″, 4 count) for a dry, non-cycled, internal bond strength test (ASTM D1037) were cut from each panel.

For the soak test each specimen was initially measured for mass, width, length and thickness. All caliper measurements were made in the center of the targeted specimen surface with a Mitutoyo ID F150E Digimatic Indicator, which was equipped with a 0.5″ diameter measurement disk. Specimens were then loaded into cages in order to ensure that they were maintained in a horizontal orientation and were then submerged in water at a temperature of 20° C. such that the top of each specimen was about 1.6 inches under the surface of the water. Each specimen was submerged in the water under these conditions for a period of 7 hours and was then removed from the water and measured for mass and thickness. Based on these measurements, calculations were made regarding the water absorption and thickness swell that had occurred during the 7-hour soaking period. In general, the following equations were used for the calculations:

Water Absorption (%)=100% [(wet specimen mass)−(initial specimen mass)]/[(initial specimen mass)]

Thickness Swell (%)=100% [(wet specimen thickness)−(initial specimen thickness)]/[(initial specimen thickness)]

The results are summarized in Table 14. In this table the individual values for replicate test specimens within a panel have been averaged together.

TABLE 14
Test Values for Oriented Strand Board Made
with an Ester (Hydrogenated Tallow Wax)

| | | | INTERNAL |
|---|---|---|---|
| | WATER | THICKNESS | BOND |
| | ABSORPTION (%) | SWELL (%) | STRENGTH |
| PANEL | IN 7 HOURS | IN 7 HOURS | (PSI) |
| 1 | 68.2 | 19.0 | 64.2 |
| 2 | 69.3 | 19.0 | 46.2 |
| 3 | 68.8 | 18.1 | 23.1 |
| 4 | 82.1 | 21.9 | 48.0 |
| 5 | 77.4 | 19.9 | 54.1 |
| 6 | 81.0 | 18.1 | 56.0 |
| AVERAGE | 74.5 | 19.3 | 48.6 |

### Example 15

Oriented strand board was produced in the laboratory with a 50/50 mixture of an ester (hydrogenated soybean oil) and an alpha olefin having a molecular weight range of about 280-364 Da.

A 4-Liter glass beaker was charged with a hydrogenated soybean oil, known as 885820 (manufactured by Archer Daniels Midland, Mankato, Minn.) (1,000 g) and an alpha olefin having a molecular weight range of about 280-364 Da, known as Neodene 26+ (manufactured by the Shell Oil Company, New Orleans, La.) (1,000 g). The contents of the beaker were heated by use of a hot plate and were gently stirred to form a low viscosity, single-phase liquid with a faint yellow tint. This mixture was cooled, which resulted in solidification (white, waxy solid), and was then stored until used to make laboratory-scale OSB. This substance was referred to as “Blend #4”.

Wooden strands (0.025-0.045 inches thick, 0.25-1.5 inches wide, 0.25-5.0 inches long, about 80% aspen and 20% black poplar) were designated as ‘core layer’ strands and were dried to a moisture content of about 3-4%. The strands were then transferred into a front-load, cylindrically-shaped, rotating blender compartment (2 feet deep and 6 feet in diameter). The axis of rotation was parallel to the laboratory floor. The rotating interior surface of the compartment was equipped with an array of protruding pegs (2 inches in length and 0.25 inches in diameter), which were effective at catching strands during rotation and carrying them to the upper region of the compartment. The rotation rate of the blender was 11 rpm. In conjunction with the pegs, this rate of rotation resulted in strands being carried to a top region of the blender and then falling to the bottom in a continuous, waterfall-like action. The blender was further equipped with spray nozzles that dispensed bonding resins and waxes into the falling strands at predetermined dosage application levels.

Blend #4 was heated to a temperature of 107° C. and sprayed onto the core strands at an application level of 0.5% of the dry mass of the strands. An isocyanate type bonding resin, known as M20FB (manufactured by the BASF Corporation, Wyandotte, Mich.) was sprayed onto the core strands at an application level of 4.3% of the dry mass of the strands. The core strands were further treated with water at an application level of 2.0% of the dry mass of the strands. The treated core layer strands were then removed from the blender.

Additional wooden strands (0.025-0.045 inches thick, 0.25-1.5 inches wide, 0.25-5.0 inches long, about 80% aspen and 20% black poplar) were designated as ‘surface layer’ strands and were dried to a moisture content of about 3-4%. The strands were then transferred into the blender compartment.

Blend #4 was heated to a temperature of 107° C. and sprayed onto the surface strands at an application level of 0.5% of the dry mass of the strands. A phenol-formaldehyde type bonding resin, known as WE1029 (manufactured by Hexion Specialty Chemicals, Columbus, Ohio) was sprayed onto the surface strands at an application level of 5.5% of the dry mass of the strands. The treated surface layer strands were then removed from the blender.

The treated strands were formed on top of an ⅛″ aluminum caul plate and a stainless-steel screen into a three-layered mat (24″ long×24″ wide) that was comprised of a bottom layer, a core layer and a top layer. The mass ratio of the outer layers to the core layer was 52:48. The strands in the top and bottom layers were generally oriented parallel to the length of the mat. The strands in the core layer were generally oriented parallel to the width of the mat. The thickness of the mat was about 5 inches and the wet mass was about 12,000 g.

The mat, as well as the underlying caul plate and screen (screen was in direct contact with the bottom of the mat), were transferred into a lab-scale, single-opening hot-press. The platens in the press had a length of 24″ and a width of 24″. The surface of the platens prior to pressing were maintained at a temperature of about 210° C. The press was immediately closed until the gap between the top and bottom platens was 0.719 inches. The closing step occurred over a 30 second period. The distance between the top and bottom platens was maintained at a distance of 0.719 inches for a period of 160 s. The gap between the top and bottom platens was then increased to 0.780 inches over a 61 second period. The press was then rapidly opened and the resulting oriented strand board panel was removed from the press and transferred into a ventilated oven at a temperature of 80° C. for a period of 24 hours. The panel was then removed from the oven and placed into a conditioning chamber (50% R.H., 20° C.) for a period of at least 5 days.

Six replicate panels were made in this manner. Test specimens (1″×1″, 6 count) for a soak test were cut from each panel. Additional test specimens (2″×2″, 4 count) for a dry, non-cycled, internal bond strength test (ASTM D1037) were cut from each panel.

For the soak test each specimen was initially measured for mass, width, length and thickness. All caliper measurements were made in the center of the targeted specimen surface with a Mitutoyo ID F150E Digimatic Indicator, which was equipped with a 0.5″ diameter measurement disk. Specimens were then loaded into cages in order to ensure that they were maintained in a horizontal orientation and were then submerged in water at a temperature of 20° C. such that the top of each specimen was about 1.6 inches under the surface of the water. Each specimen was submerged in the water under these conditions for a period of 7 hours and was then removed from the water and measured for mass and thickness. Based on these measurements, calculations were made regarding the water absorption and thickness swell that had occurred during the 7-hour soaking period. In general, the following equations were used for the calculations:

Water Absorption (%)=100% [(wet specimen mass)−(initial specimen mass)]/[(initial specimen mass)]

Thickness Swell (%)=100% [(wet specimen thickness)−(initial specimen thickness)]/[(initial specimen thickness)]

The results are summarized in Table 15. In this table the individual values for replicate test specimens within a panel have been averaged together.

TABLE 15
Test Values for Oriented Strand Board Made with a 50/50 Mixture
of an Ester (Hydrogenated Soybean Oil) and an Alpha Olefin
having a Molecular Weight Range of about 280-364 Da

| | | | INTERNAL |
|---|---|---|---|
| | WATER | THICKNESS | BOND |
| | ABSORPTION (%) | SWELL (%) | STRENGTH |
| PANEL | IN 7 HOURS | IN 7 HOURS | (PSI) |
| 1 | 69.5 | 17.3 | 33.1 |
| 2 | 63.2 | 18.1 | 52.0 |
| 3 | 59.8 | 16.1 | 48.7 |
| 4 | 74.0 | 16.1 | 48.8 |
| 5 | 65.2 | 17.2 | 49.0 |
| 6 | 70.7 | 18.8 | 46.4 |
| AVERAGE | 67.1 | 17.3 | 46.3 |

### Example 16

Oriented strand board was produced in the laboratory with a 60/40 mixture of an ester (hydrogenated tallow) and an alpha olefin having a molecular weight range of about 280-364 Da.

A 4-Liter glass beaker was charged with a hydrogenated tallow wax, known as 135V (manufactured by South Chicago Packing, Chicago, Ill.) (1,200 g) and an alpha olefin having a molecular weight range of about 280-364 Da, known as Neodene 26+ (manufactured by the Shell Oil Company, New Orleans, La.) (800 g). The contents of the beaker were heated by use of a hot plate and were gently stirred to form a low viscosity, single-phase liquid with a faint yellow tint. This mixture was cooled, which resulted in solidification (white, waxy solid), and was then stored until used to make laboratory-scale OSB. This substance was referred to as “Blend #14”.

Wooden strands (0.025-0.045 inches thick, 0.25-1.5 inches wide, 0.25-5.0 inches long, about 80% aspen and 20% black poplar) were designated as ‘core layer’ strands and were dried to a moisture content of about 3-4%. The strands were then transferred into a front-load, cylindrically-shaped, rotating blender compartment (2 feet deep and 6 feet in diameter). The axis of rotation was parallel to the laboratory floor. The rotating interior surface of the compartment was equipped with an array of protruding pegs (2 inches in length and 0.25 inches in diameter), which were effective at catching strands during rotation and carrying them to the upper region of the compartment. The rotation rate of the blender was 11 rpm. In conjunction with the pegs, this rate of rotation resulted in strands being carried to a top region of the blender and then falling to the bottom in a continuous, waterfall-like action. The blender was further equipped with spray nozzles that dispensed bonding resins and waxes into the falling strands at predetermined dosage application levels.

Blend #14 was heated to a temperature of 107° C. and sprayed onto the core strands at an application level of 0.5% of the dry mass of the strands. An isocyanate type bonding resin, known as M20FB (manufactured by the BASF Corporation, Wyandotte, Mich.) was sprayed onto the core strands at an application level of 4.3% of the dry mass of the strands. The core strands were further treated with water at an application level of 2.0% of the dry mass of the strands. The treated core layer strands were then removed from the blender.

Additional wooden strands (0.025-0.045 inches thick, 0.25-1.5 inches wide, 0.25-5.0 inches long, about 80% aspen and 20% black poplar) were designated as ‘surface layer’ strands and were dried to a moisture content of about 3-4%. The strands were then transferred into the blender compartment.

Blend #14 was heated to a temperature of 107° C. and sprayed onto the surface strands at an application level of 0.5% of the dry mass of the strands. A phenol-formaldehyde type bonding resin, known as WE1029 (manufactured by Hexion Specialty Chemicals, Columbus, Ohio) was sprayed onto the surface strands at an application level of 5.5% of the dry mass of the strands. The treated surface layer strands were then removed from the blender.

The treated strands were formed on top of an ⅛″ aluminum caul plate and a stainless-steel screen into a three-layered mat (24″ long×24″ wide) that was comprised of a bottom layer, a core layer and a top layer. The mass ratio of the outer layers to the core layer was 52:48. The strands in the top and bottom layers were generally oriented parallel to the length of the mat. The strands in the core layer were generally oriented parallel to the width of the mat. The thickness of the mat was about 5 inches and the wet mass was about 12,000 g.

The mat, as well as the underlying caul plate and screen (screen was in direct contact with the bottom of the mat), were transferred into a lab-scale, single-opening hot-press. The platens in the press had a length of 24″ and a width of 24″. The surface of the platens prior to pressing were maintained at a temperature of about 210° C. The press was immediately closed until the gap between the top and bottom platens was 0.719 inches. The closing step occurred over a 30 second period. The distance between the top and bottom platens was maintained at a distance of 0.719 inches for a period of 160 s. The gap between the top and bottom platens was then increased to 0.780 inches over a 61 second period. The press was then rapidly opened and the resulting oriented strand board panel was removed from the press and transferred into a ventilated oven at a temperature of 80° C. for a period of 24 hours. The panel was then removed from the oven and placed into a conditioning chamber (50% R.H., 20° C.) for a period of at least 5 days.

Six replicate panels were made in this manner. Test specimens (1″×1″, 6 count) for a soak test were cut from each panel. Additional test specimens (2″×2″, 4 count) for a dry, non-cycled, internal bond strength test (ASTM D1037) were cut from each panel.

For the soak test each specimen was initially measured for mass, width, length and thickness. All caliper measurements were made in the center of the targeted specimen surface with a Mitutoyo ID F150E Digimatic Indicator, which was equipped with a 0.5″ diameter measurement disk. Specimens were then loaded into cages in order to ensure that they were maintained in a horizontal orientation and were then submerged in water at a temperature of 20° C. such that the top of each specimen was about 1.6 inches under the surface of the water. Each specimen was submerged in the water under these conditions for a period of 7 hours and was then removed from the water and measured for mass and thickness. Based on these measurements, calculations were made regarding the water absorption and thickness swell that had occurred during the 7-hour soaking period. In general, the following equations were used for the calculations:

Water Absorption (%)=100% [(wet specimen mass)−(initial specimen mass)]/[(initial specimen mass)]

Thickness Swell (%)=100% [(wet specimen thickness)−(initial specimen thickness)]/[(initial specimen thickness)]

The results are summarized in Table 16. In this table the individual values for replicate test specimens within a panel have been averaged together.

TABLE 16
Test Values for Oriented Strand Board Made with a 60/40
Mixture of an Ester (Hydrogenated Tallow) and an Alpha
Olefin having a Molecular Weight Range of about 280-364 Da

| | | | INTERNAL |
|---|---|---|---|
| | WATER | THICKNESS | BOND |
| | ABSORPTION (%) | SWELL (%) | STRENGTH |
| PANEL | IN 7 HOURS | IN 7 HOURS | (PSI) |
| 1 | 64.5 | 18.1 | 52.3 |
| 2 | 70.3 | 17.4 | 34.3 |
| 3 | 69.7 | 20.0 | 45.0 |
| 4 | 67.5 | 18.3 | 39.4 |
| 5 | 71.9 | 21.1 | 35.2 |
| 6 | 70.9 | 16.0 | 49.3 |
| AVERAGE | 69.1 | 18.5 | 42.6 |

### Example 17

Oriented strand board was produced in the laboratory with a 50/25/25 mixture of an ester (hydrogenated soybean oil), an alpha olefin having a molecular weight range of about 280-364 Da, and a Fischer-Tropsch wax.

A 4-Liter glass beaker was charged with a hydrogenated soybean oil, known as 885820 (manufactured by Archer Daniels Midland, Mankato, Minn.) (1,000 g), an alpha olefin having a molecular weight range of about 280-364 Da, known as Neodene 26+ (manufactured by the Shell Oil Company, New Orleans, La.) (1,000 g), and a Fischer Tropsch wax, known as Pomona 154F (manufactured by the Shell Oil Company, New Orleans, La.) (500 g). The contents of the beaker were heated by use of a hot plate and were gently stirred to form a low viscosity, single-phase liquid with a faint yellow tint. This mixture was cooled, which resulted in solidification (white, waxy solid), and was then stored until used to make laboratory-scale OSB. This substance was referred to as “Blend #7”.

Wooden strands (0.025-0.045 inches thick, 0.25-1.5 inches wide, 0.25-5.0 inches long, about 80% aspen and 20% black poplar) were designated as ‘core layer’ strands and were dried to a moisture content of about 3-4%. The strands were then transferred into a front-load, cylindrically-shaped, rotating blender compartment (2 feet deep and 6 feet in diameter). The axis of rotation was parallel to the laboratory floor. The rotating interior surface of the compartment was equipped with an array of protruding pegs (2 inches in length and 0.25 inches in diameter), which were effective at catching strands during rotation and carrying them to the upper region of the compartment. The rotation rate of the blender was 11 rpm. In conjunction with the pegs, this rate of rotation resulted in strands being carried to a top region of the blender and then falling to the bottom in a continuous, waterfall-like action. The blender was further equipped with spray nozzles that dispensed bonding resins and waxes into the falling strands at predetermined dosage application levels.

Blend #7 was heated to a temperature of 107° C. and sprayed onto the core strands at an application level of 0.5% of the dry mass of the strands. An isocyanate type bonding resin, known as M20FB (manufactured by the BASF Corporation, Wyandotte, Mich.) was sprayed onto the core strands at an application level of 4.3% of the dry mass of the strands. The core strands were further treated with water at an application level of 2.0% of the dry mass of the strands. The treated core layer strands were then removed from the blender.

Additional wooden strands (0.025-0.045 inches thick, 0.25-1.5 inches wide, 0.25-5.0 inches long, about 80% aspen and 20% black poplar) were designated as ‘surface layer’ strands and were dried to a moisture content of about 3-4%. The strands were then transferred into the blender compartment.

Blend #7 was heated to a temperature of 107° C. and sprayed onto the surface strands at an application level of 0.5% of the dry mass of the strands. A phenol-formaldehyde type bonding resin, known as WE1029 (manufactured by Hexion Specialty Chemicals, Columbus, Ohio) was sprayed onto the surface strands at an application level of 5.5% of the dry mass of the strands. The treated surface layer strands were then removed from the blender.

The treated strands were formed on top of an ⅛″ aluminum caul plate and a stainless-steel screen into a three-layered mat (24″ long×24″ wide) that was comprised of a bottom layer, a core layer and a top layer. The mass ratio of the outer layers to the core layer was 52:48. The strands in the top and bottom layers were generally oriented parallel to the length of the mat. The strands in the core layer were generally oriented parallel to the width of the mat. The thickness of the mat was about 5 inches and the wet mass was about 12,000 g.

The mat, as well as the underlying caul plate and screen (screen was in direct contact with the bottom of the mat), were transferred into a lab-scale, single-opening hot-press. The platens in the press had a length of 24″ and a width of 24″. The surface of the platens prior to pressing were maintained at a temperature of about 210° C. The press was immediately closed until the gap between the top and bottom platens was 0.719 inches. The closing step occurred over a 30 second period. The distance between the top and bottom platens was maintained at a distance of 0.719 inches for a period of 160 s. The gap between the top and bottom platens was then increased to 0.780 inches over a 61 second period. The press was then rapidly opened and the resulting oriented strand board panel was removed from the press and transferred into a ventilated oven at a temperature of 80° C. for a period of 24 hours. The panel was then removed from the oven and placed into a conditioning chamber (50% R.H., 20° C.) for a period of at least 5 days.

Six replicate panels were made in this manner. Test specimens (1″×1″, 6 count) for a soak test were cut from each panel. Additional test specimens (2″×2″, 4 count) for a dry, non-cycled, internal bond strength test (ASTM D1037) were cut from each panel.

For the soak test each specimen was initially measured for mass, width, length and thickness. All caliper measurements were made in the center of the targeted specimen surface with a Mitutoyo ID F150E Digimatic Indicator, which was equipped with a 0.5″ diameter measurement disk. Specimens were then loaded into cages in order to ensure that they were maintained in a horizontal orientation and were then submerged in water at a temperature of 20° C. such that the top of each specimen was about 1.6 inches under the surface of the water. Each specimen was submerged in the water under these conditions for a period of 7 hours and was then removed from the water and measured for mass and thickness. Based on these measurements, calculations were made regarding the water absorption and thickness swell that had occurred during the 7-hour soaking period. In general, the following equations were used for the calculations:

Water Absorption (%)=100% [(wet specimen mass)−(initial specimen mass)]/[(initial specimen mass)]

Thickness Swell (%)=100% [(wet specimen thickness)−(initial specimen thickness)]/[(initial specimen thickness)]

The results are summarized in Table 17. In this table the individual values for replicate test specimens within a panel have been averaged together.

TABLE 17
Test Values for Oriented Strand Board Made with a
50/25/25 Mixture of an Ester (Hydrogenated Soybean
Oil), an Alpha Olefin having a Molecular Weight Range
of about 280-364 Da, and a Fischer Tropsch wax

| | | | INTERNAL |
|---|---|---|---|
| | WATER | THICKNESS | BOND |
| | ABSORPTION (%) | SWELL (%) | STRENGTH |
| PANEL | IN 7 HOURS | IN 7 HOURS | (PSI) |
| 1 | 63.1 | 16.4 | 49.7 |
| 2 | 60.1 | 16.7 | 33.4 |
| 3 | 64.3 | 18.3 | 42.6 |
| 4 | 65.7 | 17.9 | 66.7 |
| 5 | 61.1 | 19.0 | 65.5 |
| 6 | 67.8 | 19.5 | 44.1 |
| AVERAGE | 63.7 | 18.0 | 50.3 |

### Example 18

Oriented strand board was produced in the laboratory with a 50/50 mixture of an ester (hydrogenated soybean oil) and an alpha olefin having a molecular weight greater than about 420 Da.

A 4-Liter glass beaker was charged with hydrogenated soybean oil, known as 885820 (manufactured by Archer Daniels Midland, Mankato, Minn.) (1,000 g) and an alpha olefin having a molecular weight greater than about 420 Da, known as AlphaPlus C30+ (manufactured by Chevron Phillips Chemical Company, Baytown, Tex.) (1,000 g). The contents of the beaker were heated by use of a hot plate and were gently stirred to form a low viscosity, single-phase liquid with a faint yellow tint. This mixture was cooled, which resulted in solidification (white, waxy solid), and was then stored until used to make laboratory-scale OSB. This substance was referred to as “Blend #11”.

Wooden strands (0.025-0.045 inches thick, 0.25-1.5 inches wide, 0.25-5.0 inches long, about 80% aspen and 20% black poplar) were designated as ‘core layer’ strands and were dried to a moisture content of about 3-4%. The strands were then transferred into a front-load, cylindrically-shaped, rotating blender compartment (2 feet deep and 6 feet in diameter). The axis of rotation was parallel to the laboratory floor. The rotating interior surface of the compartment was equipped with an array of protruding pegs (2 inches in length and 0.25 inches in diameter), which were effective at catching strands during rotation and carrying them to the upper region of the compartment. The rotation rate of the blender was 11 rpm. In conjunction with the pegs, this rate of rotation resulted in strands being carried to a top region of the blender and then falling to the bottom in a continuous, waterfall-like action. The blender was further equipped with spray nozzles that dispensed bonding resins and waxes into the falling strands at predetermined dosage application levels.

Blend #11 was heated to a temperature of 107° C. and sprayed onto the core strands at an application level of 0.5% of the dry mass of the strands. An isocyanate type bonding resin, known as M20FB (manufactured by the BASF Corporation, Wyandotte, Mich.) was sprayed onto the core strands at an application level of 4.3% of the dry mass of the strands. The core strands were further treated with water at an application level of 2.0% of the dry mass of the strands. The treated core layer strands were then removed from the blender.

Additional wooden strands (0.025-0.045 inches thick, 0.25-1.5 inches wide, 0.25-5.0 inches long, about 80% aspen and 20% black poplar) were designated as ‘surface layer’ strands and were dried to a moisture content of about 3-4%. The strands were then transferred into the blender compartment.

Blend #11 was heated to a temperature of 107° C. and sprayed onto the surface strands at an application level of 0.5% of the dry mass of the strands. A phenol-formaldehyde type bonding resin, known as WE1029 (manufactured by Hexion Specialty Chemicals, Columbus, Ohio) was sprayed onto the surface strands at an application level of 5.5% of the dry mass of the strands. The treated surface layer strands were then removed from the blender.

The treated strands were formed on top of an ⅛″ aluminum caul plate and a stainless-steel screen into a three-layered mat (24″ long×24″ wide) that was comprised of a bottom layer, a core layer and a top layer. The mass ratio of the outer layers to the core layer was 52:48. The strands in the top and bottom layers were generally oriented parallel to the length of the mat. The strands in the core layer were generally oriented parallel to the width of the mat. The thickness of the mat was about 5 inches and the wet mass was about 12,000 g.

The mat, as well as the underlying caul plate and screen (screen was in direct contact with the bottom of the mat), were transferred into a lab-scale, single-opening hot-press. The platens in the press had a length of 24″ and a width of 24″. The surface of the platens prior to pressing were maintained at a temperature of about 210° C. The press was immediately closed until the gap between the top and bottom platens was 0.719 inches. The closing step occurred over a 30 second period. The distance between the top and bottom platens was maintained at a distance of 0.719 inches for a period of 160 s. The gap between the top and bottom platens was then increased to 0.780 inches over a 61 second period. The press was then rapidly opened and the resulting oriented strand board panel was removed from the press and transferred into a ventilated oven at a temperature of 80° C. for a period of 24 hours. The panel was then removed from the oven and placed into a conditioning chamber (50% R.H., 20° C.) for a period of at least 5 days.

Six replicate panels were made in this manner. Test specimens (1″×1″, 6 count) for a soak test were cut from each panel. Additional test specimens (2″×2″, 4 count) for a dry, non-cycled, internal bond strength test (ASTM D1037) were cut from each panel.

For the soak test each specimen was initially measured for mass, width, length and thickness. All caliper measurements were made in the center of the targeted specimen surface with a Mitutoyo ID F150E Digimatic Indicator, which was equipped with a 0.5″ diameter measurement disk. Specimens were then loaded into cages in order to ensure that they were maintained in a horizontal orientation and were then submerged in water at a temperature of 20° C. such that the top of each specimen was about 1.6 inches under the surface of the water. Each specimen was submerged in the water under these conditions for a period of 7 hours and was then removed from the water and measured for mass and thickness. Based on these measurements, calculations were made regarding the water absorption and thickness swell that had occurred during the 7-hour soaking period. In general, the following equations were used for the calculations:

Water Absorption (%)=100% [(wet specimen mass)−(initial specimen mass)]/[(initial specimen mass)]

Thickness Swell (%)=100% [(wet specimen thickness)−(initial specimen thickness)]/[(initial specimen thickness)]

The results are summarized in Table 18. In this table the individual values for replicate test specimens within a panel have been averaged together.

TABLE 18
Test Values for Oriented Strand Board Made with a 50/50 Mixture
of an Ester (Hydrogenated Soybean Oil) and an Alpha Olefin
having a Molecular Weight Greater than about 420 Da

| | | | INTERNAL |
|---|---|---|---|
| | WATER | THICKNESS | BOND |
| | ABSORPTION (%) | SWELL (%) | STRENGTH |
| PANEL | IN 7 HOURS | IN 7 HOURS | (PSI) |
| 1 | 65.8 | 17.8 | 52.3 |
| 2 | 68.9 | 18.9 | 34.5 |
| 3 | 65.7 | 18.5 | 44.1 |
| 4 | 73.1 | 17.4 | 48.2 |
| 5 | 72.0 | 20.7 | 36.8 |
| 6 | 64.5 | 20.4 | 40.8 |
| AVERAGE | 68.3 | 19.0 | 42.8 |

### Example 19

Oriented strand board was produced in the laboratory with an aqueous emulsion of a 50/25/25 mixture of an ester (hydrogenated soybean oil), an alpha olefin having a molecular weight range of about 280-364 Da, and a Fischer-Tropsch wax

A 4-Liter glass beaker was charged with a hydrogenated soybean oil, known as 885820 (manufactured by Archer Daniels Midland, Mankato, Minn.) (1,000 g), an alpha olefin having a molecular weight range of about 280-364 Da, known as Neodene 26+ (manufactured by the Shell Oil Company, New Orleans, La.) (1,000 g), and a Fischer Tropsch wax, known as Pomona 154F (manufactured by the Shell Oil Company, New Orleans, La.) (500 g). The contents of the beaker were heated by use of a hot plate and were gently stirred to form a low viscosity, single-phase liquid with a faint yellow tint. This mixture was cooled, which resulted in solidification (white, waxy solid), and was then stored until used to make laboratory-scale OSB. This substance was referred to as “Blend #7”.

An emulsion was prepared by charging a 2-L glass beaker with hot water (711.1 g, 85° C.), a lignosulfonate solution (9.0 g), known as Borrersperse AM 870L (manufactured by Borregaard LignoTech Incorporated, Toronto, ON, Canada), and hot blend #7 (480.0 g, 85° C.). The beaker was placed on a hot plate and stirred with a magnetic stirring bar in order to achieve and maintain a coarse emulsion at a temperature of 85° C. The mixture was then processed in a Silverson L5MA mixer with an Emulsor screen work head in order to achieve a hot emulsion that was stable for about 2-5 minutes.

Wooden strands (0.025-0.045 inches thick, 0.25-1.5 inches wide, 0.25-5.0 inches long, about 80% aspen and 20% black poplar) were designated as ‘core layer’ strands and were dried to a moisture content of about 3-4%. The strands were then transferred into a front-load, cylindrically-shaped, rotating blender compartment (2 feet deep and 6 feet in diameter). The axis of rotation was parallel to the laboratory floor. The rotating interior surface of the compartment was equipped with an array of protruding pegs (2 inches in length and 0.25 inches in diameter), which were effective at catching strands during rotation and carrying them to the upper region of the compartment. The rotation rate of the blender was 11 rpm. In conjunction with the pegs, this rate of rotation resulted in strands being carried to a top region of the blender and then falling to the bottom in a continuous, waterfall-like action. The blender was further equipped with spray nozzles that dispensed bonding resins and waxes into the falling strands at predetermined dosage application levels.

Freshly emulsified Blend #7 (85° C.) was sprayed onto the core strands at an application level of 0.5% (wax solids) of the dry mass of the strands. An isocyanate type bonding resin, known as M20FB (manufactured by the BASF Corporation, Wyandotte, Mich.) was sprayed onto the core strands at an application level of 4.3% of the dry mass of the strands. The core strands were further treated with water at an application level of 2.0% of the dry mass of the strands. The treated core layer strands were then removed from the blender.

Additional wooden strands (0.025-0.045 inches thick, 0.25-1.5 inches wide, 0.25-5.0 inches long, about 80% aspen and 20% black poplar) were designated as ‘surface layer’ strands and were dried to a moisture content of about 3-4%. The strands were then transferred into the blender compartment.

Freshly emulsified Blend #7 (85° C.) was sprayed onto the surface strands at an application level of 0.5% (wax solids) of the dry mass of the strands. A phenol-formaldehyde type bonding resin, known as WE1029 (manufactured by Hexion Specialty Chemicals, Columbus, Ohio) was sprayed onto the surface strands at an application level of 5.5% of the dry mass of the strands. The treated surface layer strands were then removed from the blender.

The treated strands were formed on top of an ⅛″ aluminum caul plate and a stainless-steel screen into a three-layered mat (24″ long×24″ wide) that was comprised of a bottom layer, a core layer and a top layer. The mass ratio of the outer layers to the core layer was 52:48. The strands in the top and bottom layers were generally oriented parallel to the length of the mat. The strands in the core layer were generally oriented parallel to the width of the mat. The thickness of the mat was about 5 inches and the wet mass was about 12,000 g.

The mat, as well as the underlying caul plate and screen (screen was in direct contact with the bottom of the mat), were transferred into a lab-scale, single-opening hot-press. The platens in the press had a length of 24″ and a width of 24″. The surface of the platens prior to pressing were maintained at a temperature of about 210° C. The press was immediately closed until the gap between the top and bottom platens was 0.719 inches. The closing step occurred over a 30 second period. The distance between the top and bottom platens was maintained at a distance of 0.719 inches for a period of 160 s. The gap between the top and bottom platens was then increased to 0.780 inches over a 61 second period. The press was then rapidly opened and the resulting oriented strand board panel was removed from the press and transferred into a ventilated oven at a temperature of 80° C. for a period of 24 hours. The panel was then removed from the oven and placed into a conditioning chamber (50% R.H., 20° C.) for a period of at least 5 days.

Six replicate panels were made in this manner. Test specimens (1″×1″, 6 count) for a soak test were cut from each panel. Additional test specimens (2″×2″, 4 count) for a dry, non-cycled, internal bond strength test (ASTM D1037) were cut from each panel.

For the soak test each specimen was initially measured for mass, width, length and thickness. All caliper measurements were made in the center of the targeted specimen surface with a Mitutoyo ID F150E Digimatic Indicator, which was equipped with a 0.5″ diameter measurement disk. Specimens were then loaded into cages in order to ensure that they were maintained in a horizontal orientation and were then submerged in water at a temperature of 20° C. such that the top of each specimen was about 1.6 inches under the surface of the water. Each specimen was submerged in the water under these conditions for a period of 7 hours and was then removed from the water and measured for mass and thickness. Based on these measurements, calculations were made regarding the water absorption and thickness swell that had occurred during the 7-hour soaking period. In general, the following equations were used for the calculations:

Water Absorption (%)=100% [(wet specimen mass)−(initial specimen mass)]/[(initial specimen mass)]

Thickness Swell (%)=100% [(wet specimen thickness)−(initial specimen thickness)]/[(initial specimen thickness)]

The results are summarized in Table 19. In this table the individual values for replicate test specimens within a panel have been averaged together.

TABLE 19
Test Values for Oriented Strand Board Made with an Emulsified
50/25/25 Mixture of an Ester (Hydrogenated Soybean
Oil), an Alpha Olefin having a Molecular Weight Range
of about 280-364 Da, and a Fischer-Tropsch Wax

| | | | INTERNAL |
|---|---|---|---|
| | WATER | THICKNESS | BOND |
| | ABSORPTION (%) | SWELL (%) | STRENGTH |
| PANEL | IN 7 HOURS | IN 7 HOURS | (PSI) |
| 1 | 49.8 | 13.4 | 59.7 |
| 2 | 50.6 | 15.0 | 60.2 |
| 3 | 52.4 | 15.4 | 53.8 |
| 4 | 56.6 | 15.5 | 56.8 |
| 5 | 54.8 | 16.5 | 57.3 |
| 6 | 58.2 | 16.9 | 52.0 |
| AVERAGE | 53.7 | 15.5 | 56.6 |

### Example 20

Oriented strand board was produced in the laboratory with an aqueous emulsion of a conventional petroleum-based slack wax.

An emulsion was prepared by charging a 2-L glass beaker with hot water (702.0 g, 85° C.), a lignosulfonate solution (18.0 g), known as Borrersperse AM 870L (manufactured by Borregaard LignoTech Incorporated, Toronto, ON, Canada), and a petroleum-based slack wax, known as ProWax 561 (manufactured by the ExxonMobil Corporation, Baytown, Tex.) (480.0 g, 85° C.). The beaker was placed on a hot plate and stirred with a magnetic stirring bar in order to achieve and maintain a coarse emulsion at a temperature of 85° C. The mixture was then processed in a Silverson L5MA mixer with an Emulsor screen work head in order to achieve a hot emulsion that was stable for about 2-5 minutes.

Wooden strands (0.025-0.045 inches thick, 0.25-1.5 inches wide, 0.25-5.0 inches long, about 80% aspen and 20% black poplar) were designated as ‘core layer’ strands and were dried to a moisture content of about 3-4%. The strands were then transferred into a front-load, cylindrically-shaped, rotating blender compartment (2 feet deep and 6 feet in diameter). The axis of rotation was parallel to the laboratory floor. The rotating interior surface of the compartment was equipped with an array of protruding pegs (2 inches in length and 0.25 inches in diameter), which were effective at catching strands during rotation and carrying them to the upper region of the compartment. The rotation rate of the blender was 11 rpm. In conjunction with the pegs, this rate of rotation resulted in strands being carried to a top region of the blender and then falling to the bottom in a continuous, waterfall-like action. The blender was further equipped with spray nozzles that dispensed bonding resins and waxes into the falling strands at predetermined dosage application levels.

Freshly emulsified ProWax 561 (85° C.) was sprayed onto the core strands at an application level of 0.5% (wax solids) of the dry mass of the strands. An isocyanate type bonding resin, known as M20FB (manufactured by the BASF Corporation, Wyandotte, Mich.) was sprayed onto the core strands at an application level of 4.3% of the dry mass of the strands. The core strands were further treated with water at an application level of 2.0% of the dry mass of the strands. The treated core layer strands were then removed from the blender.

Additional wooden strands (0.025-0.045 inches thick, 0.25-1.5 inches wide, 0.25-5.0 inches long, about 80% aspen and 20% black poplar) were designated as ‘surface layer’ strands and were dried to a moisture content of about 3-4%. The strands were then transferred into the blender compartment.

Freshly emulsified ProWax 561 (85° C.) was sprayed onto the surface strands at an application level of 0.5% (wax solids) of the dry mass of the strands. A phenol-formaldehyde type bonding resin, known as WE1029 (manufactured by Hexion Specialty Chemicals, Columbus, Ohio) was sprayed onto the surface strands at an application level of 5.5% of the dry mass of the strands. The treated surface layer strands were then removed from the blender.

The treated strands were formed on top of an ⅛″ aluminum caul plate and a stainless-steel screen into a three-layered mat (24″ long×24″ wide) that was comprised of a bottom layer, a core layer and a top layer. The mass ratio of the outer layers to the core layer was 52:48. The strands in the top and bottom layers were generally oriented parallel to the length of the mat. The strands in the core layer were generally oriented parallel to the width of the mat. The thickness of the mat was about 5 inches and the wet mass was about 12,000 g.

The mat, as well as the underlying caul plate and screen (screen was in direct contact with the bottom of the mat), were transferred into a lab-scale, single-opening hot-press. The platens in the press had a length of 24″ and a width of 24″. The surface of the platens prior to pressing were maintained at a temperature of about 210° C. The press was immediately closed until the gap between the top and bottom platens was 0.719 inches. The closing step occurred over a 30 second period. The distance between the top and bottom platens was maintained at a distance of 0.719 inches for a period of 160 s. The gap between the top and bottom platens was then increased to 0.780 inches over a 61 second period. The press was then rapidly opened and the resulting oriented strand board panel was removed from the press and transferred into a ventilated oven at a temperature of 80° C. for a period of 24 hours. The panel was then removed from the oven and placed into a conditioning chamber (50% R.H., 20° C.) for a period of at least 5 days.

Six replicate panels were made in this manner. Test specimens (1″×1″, 6 count) for a soak test were cut from each panel. Additional test specimens (2″×2″, 4 count) for a dry, non-cycled, internal bond strength test (ASTM D1037) were cut from each panel.

For the soak test each specimen was initially measured for mass, width, length and thickness. All caliper measurements were made in the center of the targeted specimen surface with a Mitutoyo ID F150E Digimatic Indicator, which was equipped with a 0.5″ diameter measurement disk. Specimens were then loaded into cages in order to ensure that they were maintained in a horizontal orientation and were then submerged in water at a temperature of 20° C. such that the top of each specimen was about 1.6 inches under the surface of the water. Each specimen was submerged in the water under these conditions for a period of 7 hours and was then removed from the water and measured for mass and thickness. Based on these measurements, calculations were made regarding the water absorption and thickness swell that had occurred during the 7-hour soaking period. In general, the following equations were used for the calculations:

Water Absorption (%)=100% [(wet specimen mass)−(initial specimen mass)]/[(initial specimen mass)]

Thickness Swell (%)=100% [(wet specimen thickness)−(initial specimen thickness)]/[(initial specimen thickness)]

The results are summarized in Table 20. In this table the individual values for replicate test specimens within a panel have been averaged together.

TABLE 20
Test Values for Oriented Strand Board Made with Emulsified
Conventional Petroleum-Based Slack Wax (ProWax 561)

| | | | INTERNAL |
|---|---|---|---|
| | WATER | THICKNESS | BOND |
| | ABSORPTION (%) | SWELL (%) | STRENGTH |
| PANEL | IN 7 HOURS | IN 7 HOURS | (PSI) |
| 1 | 49.6 | 15.3 | 74.5 |
| 2 | 49.4 | 15.4 | 42.9 |
| 3 | 54.8 | 14.7 | 56.5 |
| 4 | 62.4 | 15.5 | 47.5 |
| 5 | 51.9 | 14.1 | 70.5 |
| 6 | 58.2 | 17.4 | 44.0 |
| AVERAGE | 54.4 | 15.4 | 56.0 |

The results of examples 1-20 are summarized in Table 21.

TABLE 21
Summary of Test Values for Oriented Strand Board Made with Different Wax Types

| | | | AVERAGE |
|---|---|---|---|
| | AVERAGE | AVERAGE | INTERNAL |
| | WATER | THICKNESS | BOND |
| | ABSORPTION (%) | SWELL (%) | STRENGTH |
| WAX TYPE | IN 7 HOURS | IN 7 HOURS | (PSI) |
| NO WAX | 85.4 | 22.0 | 50.6 |
| FIRST CONVENTIONAL | 55.5 | 15.6 | 51.9 |
| PETROLEUM SLACK WAX | | | |
| (431B) | | | |
| SECOND CONVENTIONAL | 55.1 | 16.0 | 49.7 |
| PETROLEUM SLACK WAX | | | |
| (PROWAX 561) | | | |
| ESTER ONLY (HSBO) | 71.8 | 19.5 | 51.0 |
| ESTER ONLY (HYDROG. | 74.5 | 19.3 | 48.6 |
| TALLOW) | | | |
| ALPHA OLEFIN ONLY | 47.0 | 14.3 | 41.6 |
| (280-364Da) | | | |
| ALPHA OLEFIN ONLY | 56.6 | 15.4 | 42.9 |
| (>420 Da) | | | |
| 50:50 MIXTURE OF ESTER | 61.0 | 16.4 | 49.3 |
| (HSBO):ALPHA OLEFIN | | | |
| (280-364 Da) | | | |
| 60:40 MIXTURE OF ESTER | 59.8 | 16.5 | 50.4 |
| (HSBO):ALPHA OLEFIN | | | |
| (280-364 Da) | | | |
| 70:30 MIXTURE OF ESTER | 62.0 | 17.7 | 48.1 |
| (HSBO):ALPHA OLEFIN | | | |
| (280-364 Da) | | | |
| 60:40 MIXTURE OF ESTER | 69.1 | 18.5 | 42.6 |
| (HYDROG TALLOW):ALPHA | | | |
| OLEFIN (280-364 Da) | | | |
| 50:50 MIXTURE OF ESTER | 68.3 | 19.0 | 42.8 |
| (HSBO):ALPHA OLEFIN | | | |
| (>420 Da) | | | |
| 50:25:25 MIXTURE OF ESTER | 63.7 | 18.0 | 50.3 |
| (HSBO):ALPHA OLEFIN | | | |
| (280-364 Da):FISCHER | | | |
| TROPSCH WAX | | | |
| EMULSION OF 50:25:25 | 53.7 | 15.5 | 56.6 |
| MIXTURE OF ESTER | | | |
| (HSBO):ALPHA OLEFIN | | | |
| (280-364 Da):FISCHER | | | |
| TROPSCH WAX | | | |
| EMULSION OF CONVENTIONAL | 54.4 | 15.4 | 56.0 |
| PETROLEUM SLACK WAX | | | |
| (PROWAX 561) | | | |

Table 21 suggests that the alpha olefins, when used without modification, might be associated with reduced internal bond strength in oriented strand board made with a phenol-formaldehyde resin in the surface layer and an isocyanate binder in the core layer. The table also provides an indication that alpha olefins with a molecular weight of about 280-364 Da might be associated with superior reductions in water absorption rate and thickness swell when compared to conventional petroleum-based slack wax.

Moreover, Table 21 indicates the adverse impact of the alpha olefin on bond strength could be avoided by addition of the ester, when the ester by itself did not appear to significantly improve bond strength. Most of the performance effect on water absorption and thickness swell of the alpha olefin was preserved when we compounded it with the ester, even when the ester represented 50-70% of the mixture.

### Example 21

Wax samples were measured for volatility at elevated temperature in the following manner.

Aluminum pans (5.08 cm diameter circular base) were marked with a sharpie and weighed to the nearest 10 thousandth of a gram (0.0000). A wax sample (about 2 g) was added to the pan. The loaded pan was weighed to the nearest 10 thousandth of a gram (0.0000). The loaded pan was heated in a ventilated oven (163° C.) for a period of 120 minutes. The pan was then removed from the oven and allowed to cool (20° C.) for a period of 5 minutes. The cooled pan was then weighed to the nearest 10 thousandth of a gram (0.0000). Based on the loss in mass the amount of evaporated wax was determined. Based on the surface area of wax exposed to air in the bottom of the pan and the time in the oven, the evaporation flux rate was calculated in units of mg/min/m². The measurements were conducted in triplicate.

Average test values for different waxes are shown in Table 22.

TABLE 22
Wax Volatility at Elevated Temperature

| | WAX VOLATILITY AT |
|---|---|
| | A TEMPERATURE OF |
| | 163° C. |
| WAX TYPE | (mg/min/m²) |
| FIRST CONVENTIONAL | 121 |
| PETROLEUM SLACK WAX | |
| (431B) | |
| SECOND CONVENTIONAL | 37.7 |
| PETROLEUM SLACK WAX | |
| (PROWAX 561) | |
| ESTER ONLY (HSBO) | <1 |
| ESTER ONLY (HYDROG. | 6.5 |
| TALLOW) | |
| ALPHA OLEFIN ONLY | 328 |
| (280-364 Da) | |
| ALPHA OLEFIN ONLY | <1 |
| (>420 Da) | |
| 50:50 MIXTURE OF ESTER | 164 |
| (HSBO):ALPHA OLEFIN | |
| (280-364 Da) | |
| 60:40 MIXTURE OF ESTER | 138 |
| (HSBO):ALPHA OLEFIN | |
| (280-364 Da) | |
| 70:30 MIXTURE OF ESTER | 111 |
| (HSBO):ALPHA OLEFIN | |
| (280-364 Da) | |
| 60:40 MIXTURE OF ESTER | 184 |
| (HYDROG TALLOW):ALPHA | |
| OLEFIN (280-364 Da) | |
| 50:50 MIXTURE OF ESTER | 10.8 |
| (HSBO):ALPHA OLEFIN | |
| (>420 Da) | |
| 50:25:25 MIXTURE OF ESTER | 96.9 |
| (HSBO):ALPHA OLEFIN | |
| (280-364 Da):FISCHER | |
| TROPSCH WAX | |

Slack wax products used in the wood-based composites industry can have wax volatility values using this test method that range from about 10-1000 mg/min/m² at 163° C. We would suggest that a preferred range for volatility is about 20-250 mg/min/m² at 163° C. Interestingly, in some cases the volatility of the mixtures of ester and alpha olefin generally reflect the weighted average of the volatility of the individual components and in other cases the volatility of the mixtures of ester and alpha olefins do not reflect the weighted average of the volatility of the components. For example, the volatility of the 60:40 mixture of hydrogenated tallow:alpha olefin (280-364 Da) is substantially greater than that which we would predicted based on the volatility of the individual components.

Several embodiments of the present technology are further described below with respect to Examples 22-46:

22. A wood composition, comprising:
wood elements;
a bonding resin comprising 2.0-7.0% of the dry mass of the wood elements; and
a wax composition comprising 0.1-3.0% of the dry mass of the wood elements, wherein the wax composition is a mixture of alpha olefins and esters, and wherein the mass ratio of the alpha olefins to the esters is between 2:8 and 8:2.

23. The wood composition of example 22, wherein the molecular weight of the alpha olefins is between 240 and 400 Daltons.

24. The wood composition of examples 22 or 23, wherein the esters are hydrogenated soybean oil, hydrogenated castor oil, hydrogenated cotton seed oil, hydrogenated sunflower oil, tallow, and/or hydrogenated tallow.

25. The wood composition of any one of examples 22-24, wherein the wax composition has a kinematic viscosity of about 10 cPs or less and a freezing point between 55 and 60 degrees Celsius. 26. The wood composition of any one of examples 22-25, wherein the wood composition is formed into an oriented strand board.

27. A wax composition for use in wood-based composites, the wax composition comprising a mixture of alpha olefins and esters, wherein the alpha olefins have a molecular weight between 240 and 400 Daltons, and wherein the mass ratio of the alpha olefins to the esters is between 2:8 and 8:2.

28. The wax composition of example 27, wherein the molecular weight of the alpha olefins is between 280 and 364 Daltons.

29. The wax composition of examples 27 or 28, wherein the alpha olefins contain between about 20 and 26 carbon atoms.

30. The wax composition of any one of examples 27-29, wherein the alpha olefins have a melting point between 35 and 80 degrees Celsius.

31. The wax composition of any one of examples 27-30, wherein the alpha olefins include two or more different alpha olefins.

32. The wax composition of any one of examples 27-31, wherein the esters comprise compounds with one, two, and/or three ester functional groups.

33. The wax composition of any one of examples 27-32, wherein the esters are hydrogenated soybean oil, hydrogenated castor oil, hydrogenated cotton seed oil, hydrogenated sunflower oil, tallow, and/or hydrogenated tallow.

34. The wax composition of any one of examples 27-33, wherein the esters include two or more different esters.

35. The wax composition of any one of examples 27-34, wherein the esters have a melting point between 30 and 60 degrees.

36. The wax composition of any one of examples 27-35, wherein the mass ratio of the alpha olefins to the esters is between 3:7 and 7:3.

37. The wax composition of any one of examples 27-36, wherein the mass ratio of the alpha olefins to the esters is between 5:5 and 7:3.

38. The wax composition of any one of examples 27-37, further comprising a hydrocarbon wax, a Fischer-Tropsch wax, a petroleum wax, or a paraffin wax.

39. The wax composition of any one of examples 27-38, wherein the wax composition is a molten wax composition.

40. The wax composition of any one of examples 27-39, wherein the wax composition is emulsified in a water-based emulsion.

41. The wax composition of any one of examples 27-40, wherein the wax composition has a kinematic viscosity of about 10 cPs or less and a freezing point between 55 and 60 degrees Celsius.

42. A method of manufacturing a wood-based composite, the method comprising:
providing wood elements;
drying wood elements to a moisture content of 2.0-12%;
applying a bonding resin to the wood elements;
applying a wax composition to the wood elements, wherein the wax composition comprises a mixture of alpha olefins and esters, and wherein the alpha olefins have a molecular weight between 240 and 400 Daltons, and wherein the mass ratio of alpha olefins to esters is between 2:8 and 8:2; and
forming the wood elements into one or more wood-based composites. 43. The method of example 42, wherein applying the wax composition to the wood elements comprises spraying the wax composition on the wood elements.

44. The method of examples 42 or 43, wherein applying the wax composition to the wood elements comprises injecting the wax composition into a blender configured to mix the wood elements.

45. The method of any one of examples 42-44, wherein the esters are hydrogenated soybean oil, hydrogenated castor oil, hydrogenated cotton seed oil, hydrogenated sunflower oil, tallow, and/or hydrogenated tallow.

46. The method of any one of examples 42-45, wherein the wax composition has a kinematic viscosity of about 10 cPs or less and a freezing point between 55 and 60 degrees Celsius.

### Conclusion

As can be appreciated from the foregoing disclosure, the representative systems and methods described above may be combined in various manners to achieve desired results. Accordingly, this disclosure is not intended to be exhaustive or to limit the present technology to the precise forms disclosed herein. Although specific embodiments are disclosed herein for illustrative purposes, various equivalent modifications are possible without deviating from the present technology, as those of ordinary skill in the art will recognize. In some cases, well-known structures and functions have not been shown or described in detail to avoid unnecessarily obscuring the description of the embodiments of the present technology. Although steps of methods may be presented herein in a particular order, alternative embodiments may perform the steps in a different order. Similarly, certain aspects of the present technology disclosed in the context of particular embodiments can be combined or eliminated in other embodiments. Furthermore, while advantages associated with certain embodiments of the present technology may have been disclosed in the context of those embodiments, other embodiments of the present technology may have been disclosed in the context of those embodiments, other embodiments can also exhibit such advantages, and not all embodiments need necessarily exhibit such advantages or other advantages disclosed herein to fall within the scope of the technology. Accordingly, the disclosure and associated technology can encompass other embodiments not expressly shown or described herein.

Throughout this disclosure, the singular terms “a,”, “an,” and “the” include plural referents unless the context clearly indicates otherwise. Similarly, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of items in the list. Additionally, the term “comprising” is used throughout to mean including at least the recited feature(s) such that any greater number of the same feature and/or additional types of other features are not precluded. Reference herein to “one embodiment,” “an embodiment,” or similar formulations means that a particular feature, structure, operation, or characteristic described in connection with the embodiment can be included in at least one embodiment of the present technology. Thus, the appearances of such phrases or formulations herein are not necessarily all referring to the same embodiment. Furthermore, various particular features, structures, operations, or characteristics may be combined in any suitable manner in one or more embodiments.

I/we claim:

1. A wood composition, comprising:
wood elements;
a bonding resin comprising 2.0-7.0% of the dry mass of the wood elements; and
a wax composition comprising 0.1-3.0% of the dry mass of the wood elements, wherein the wax composition is a mixture of alpha olefins and esters, and wherein the mass ratio of the alpha olefins to the esters is between 2:8 and 8:2.

2. The wood composition of claim 1, wherein the molecular weight of the alpha olefins is between 240 and 400 Daltons.

3. The wood composition of claim 1, wherein the esters are hydrogenated soybean oil, hydrogenated castor oil, hydrogenated cotton seed oil, hydrogenated sunflower oil, tallow, and/or hydrogenated tallow.

4. The wood composition of claim 1, wherein the wax composition has a kinematic viscosity of about 10 cPs or less and a freezing point between 55 and 60 degrees Celsius.

5. The wood composition of claim 1, wherein the wood composition is formed into an oriented strand board.

6. A wax composition for use in wood-based composites, the wax composition comprising a mixture of alpha olefins and esters, wherein the alpha olefins have a molecular weight between 240 and 400 Daltons, and wherein the mass ratio of the alpha olefins to the esters is between 2:8 and 8:2.

7. The wax composition of claim 6, wherein the molecular weight of the alpha olefins is between 280 and 364 Daltons.

8. The wax composition of claim 6, wherein the alpha olefins contain between about 20 and 26 carbon atoms.

9. The wax composition of claim 6, wherein the alpha olefins have a melting point between 35 and 80 degrees Celsius.

10. The wax composition of claim 6, wherein the alpha olefins include two or more different alpha olefins.

11. The wax composition of claim 6, wherein the esters comprise compounds with one, two, and/or three ester functional groups.

12. The wax composition of claim 6, wherein the esters are hydrogenated soybean oil, hydrogenated castor oil, hydrogenated cotton seed oil, hydrogenated sunflower oil, tallow, and/or hydrogenated tallow.

13. The wax composition of claim 6, wherein the esters include two or more different esters.

14. The wax composition of claim 6, wherein the esters have a melting point between 30 and 60 degrees.

15. The wax composition of claim 6, wherein the mass ratio of the alpha olefins to the esters is between 3:7 and 7:3.

16. The wax composition of claim 6, wherein the mass ratio of the alpha olefins to the esters is between 5:5 and 7:3.

17. The wax composition of claim 6, further comprising a hydrocarbon wax, a Fischer-Tropsch wax, a petroleum wax, or a paraffin wax.

18. The wax composition of claim 6, wherein the wax composition is a molten wax composition.

19. The wax composition of claim 6, wherein the wax composition is emulsified in a water-based emulsion.

20. The wax composition of claim 6, wherein the wax composition has a kinematic viscosity of about 10 cPs or less and a freezing point between 55 and 60 degrees Celsius.

21. A method of manufacturing a wood-based composite, the method comprising:
providing wood elements;
drying the wood elements to a moisture content of 2.0-12%;
applying a bonding resin to the wood elements;
applying a wax composition to the wood elements, wherein the wax composition comprises a mixture of alpha olefins and esters, and wherein the alpha olefins have a molecular weight between 240 and 400 Daltons, and wherein the mass ratio of alpha olefins to esters is between 2:8 and 8:2; and
forming the wood elements into one or more wood-based composites.

22. The method of claim 21, wherein applying the wax composition to the wood elements comprises spraying the wax composition on the wood elements.

23. The method of claim 21, wherein applying the wax composition to the wood elements comprises injecting the wax composition into a blender configured to mix the wood elements.

24. The method of claim 21, wherein the esters are hydrogenated soybean oil, hydrogenated castor oil, hydrogenated cotton seed oil, hydrogenated sunflower oil, tallow, and/or hydrogenated tallow.

25. The method of claim 21, wherein the wax composition has a kinematic viscosity of about 10 cPs or less and a freezing point between 55 and 60 degrees Celsius.
